(19) United States
(12) Patent Application Publication
(10) Pub. No.: US 2014/0337008 A1
(43) Pub. Date: Nov. 13, 2014

(54) IMAGE PROCESSING APPARATUS, IMAGE FORMING APPARATUS, PROGRAM AND STORAGE MEDIUM

(71) Applicant: SHARP KABUSHIKI KAISHA, Osaka-shi, Osaka (JP)

(72) Inventors: Atsuhisa Morimoto, Osaka-shi (JP); Yohsuke Konishi, Osaka-shi (JP); Hitoshi Hirohata, Osaka-shi (JP); Akihito Yoshida, Osaka-shi (JP)

(21) Appl. No.: 14/370,170

(22) PCT Filed: Jan. 15, 2013
(86) PCT No.: PCT/JP2013/050584

§ 371 Date: Jul. 1, 2014

(30) Foreign Application Priority Data
Jan. 16, 2012 (JP) 2012-005991

(51) Int. Cl. H04N 1/00; G06F 17/21; G06K 15/02; G06F 17/28

(52) U.S. Cl. CPC H04N 1/0044; G06F 17/28; G06F 17/214; G06K 15/1811; H04N 2201/0094
USPC 704/3

(57) ABSTRACT

An image processing apparatus (3) includes: a translation section (32) carrying out a translation process of a language contained in image data; and a formatting process section (34) generating an image file, in accordance with the image data and a result of the translation process. The formatting process section (34) embeds, in the image file, a command for causing a computer to switch between a first display state in which the language and the translated word are displayed together and a second display state in which the language is displayed without the translated word in a case where a user gives, with respect to the image file, a switching instruction to switch between the first display state and the second display state.

### TECHNICAL FIELD

The present invention relates to an image processing apparatus having a function of translating a language in image data, an image forming apparatus, a program, and a storage medium storing the program.

### BACKGROUND ART

There is a conventionally known multifunction peripheral that has functions of (i) carrying out character recognition on inputted image data (electronic document), (ii) translating recognized characters (original text), and (iii) generating a PDF file containing an image (an image with a translation) where both the original text and a translated text are written.

There also is a known technique according to which, when an image where a translated text is written together with an original text is to be generated, a position where the translated text is to be inserted is determined in accordance with a document configuration in the image. For example, the following Patent Literature 1 discloses the steps of (i) obtaining a translated word(s) (translation information) corresponding to text information contained in image data, (ii) obtaining information indicative of a region where the translated word(s) is to be inserted in accordance with an arrangement of text lines containing the text information, and (iii) determining the position where the translated word(s) are to be inserted, in accordance with the region information obtained. More specifically, the technique of Patent Literature 1 is arranged so that only a reference index is inserted between text lines and a corresponding translated word is inserted in a bottom margin in a case where a space between text lines in the image data is equal to or less than a predetermined level.

### CITATION LIST

### Patent Literature

Patent Literature 1
Japanese Patent Application Publication,
Tokukai, No. 2009-294788 A
Patent Literature 2
Japanese Patent Application Publication,
Tokukaihei, No. 7-192086 (1995) A
Patent Literature 3
Japanese Patent Application Publication,
Tokukaihei, No. 6-189083 (1994) A

### SUMMARY OF INVENTION

### Technical Problem

However, a user who browses a PDF file (hereinafter, referred to as “file”) is not limited to a user who generated the file. When users who are not the user who generated the file browse the file, some of the users find that translated words (a visualized translation in the form of ruby characters) written with an original text are annoying or unnecessary. Accordingly, when a case where the above file is assumed to be browsed by a lot of users, it is required to generate not only a file where translated words are written together with the original text but also a file where no translated word is written with the original text. The file where translated words are written together is obtained by reading a document by use of a multifunction peripheral where a function setting for providing the translated words is turned on, while the file where no translated word is written is obtained by reading the document by use of the multifunction peripheral where the function setting for providing translated words is turned off. However, in such a case, a user is troubled to cause the multifunction peripheral to read the document twice. Even in a case where such files are generated based on electronic data stored (e.g., in a case where application software that operates in conjunction with the multifunction peripheral is used), it is required to carry out not only a process for generating a file where translated words are written with an original text but also a process for generating a file where no translated word is written with the original text in a case where it is assumed that many users are to browse the file. Then, the user who generates the files is required to forcibly provide labor for carrying out operations for such processes.

Further, generating both the file where translated words are written and the file where no translated word is written means generating two files that correspond to single contents of a document. This causes trouble in file management.

The present invention is attained in view of the above problems. An object of the present invention is to provide an image processing apparatus that reduces labor in generating image files and trouble in managing files, an image forming apparatus, a program, and a storage medium.

### Solution to Problem

In order to achieve the above object, an image processing apparatus of the present invention includes: a translation section carrying out a translation process of a language contained in image data so as to specify a translated word corresponding to the language; and a formatting process section generating an image file formatted into data in a predetermined format, in accordance with the image data and a result of the translation process, the formatting process section adding, to the image file, a command for causing a computer to switch between a first display state in which the language and the translated word are displayed together and a second display state in which the language is displayed without the translated word in a case where a user gives, with respect to the image file, a switching instruction to switch between the first display state and the second display state.

### Advantageous Effects of Invention

According to the present invention, it is possible to generate a single image file that allows switching as necessary between the first display state in which the language and the translated word are displayed together and the second display state in which the language is displayed without the translated word. Accordingly, this arrangement advantageously makes it possible to save labor in generating files and trouble in managing files, as compared to a case where two files are generated as in the conventional technique.

### BRIEF DESCRIPTION OF DRAWINGS

FIG. 1 is a block diagram schematically illustrating an arrangement of an image forming apparatus including an image processing apparatus according to one embodiment of the present invention.

FIG. 2 is a block diagram illustrating an internal configuration of a document detection section illustrated in FIG. 1.

FIG. 3 is a block diagram illustrating an internal configuration of a file generation section illustrated in FIG. 1.

(a) of FIG. 4 is a view illustrating an image that is displayed in a state without translated words. (b) of FIG. 4 is a view illustrating an image that is displayed in a state with translated words.

FIG. 5 is a flow chart illustrating a flow of processes carried out by the image forming apparatus in an image transmitting mode.

(a) of FIG. 6 is a view schematically illustrating a switching button that is semi-transparent. (b) of FIG. 6 is a view schematically illustrating the switching button that is turned non-transparent by rollover of the switching button illustrated in (a) of FIG. 6.

(a) of FIG. 7 is a view illustrating a document catalogue that is described in an image file. (b) of FIG. 7 is an optional content group dictionary that is described in the image file. (c) of FIG. 7 is a view illustrating a description of information described in the image file, the description being relevant to specification of an optional content area.

(a) of FIG. 8 is a view illustrating a page object described in an image file. (b) of FIG. 8 is a view illustrating a Widget annotation that is described in the image file. (c) of FIG. 8 is a view illustrating a form XObject that is described in the image file.

FIG. 9 is a view illustrating information that is described in an image file and that is for printing a switching button at the time of printing.

FIG. 10 is a view illustrating information that is described in an image file and that is for specifying the state without translated words as illustrated in (a) of FIG. 4, as an initial display state at the time when the image file is opened by a user.

(a) of FIG. 11 is a view illustrating a Widget annotation that is described in an image file configured to display a switching button that is semi-transparent. (b) of FIG. 11 is a view illustrating a graphics-state parameter dictionary that is described in the image file configured to display the switching button that is semi-transparent. (c) of FIG. 11 is a view illustrating a form XObject that is described in the image file configured to display the switching button that is semi-transparent.

FIG. 12 is a view illustrating a configuration of an image file of an embodiment of the present invention.

FIG. 13 is a view illustrating a configuration of an image file including a plurality of pages for each of which a state with translated words and a state without translated words can be switched each other.

FIG. 14 is a view illustrating a configuration of an image file including a plurality of pages for all of which a state with translated words and a state without translated words can be switched each other in a batch.

FIG. 15 is a view illustrating a configuration of an image file including a plurality of translated-word images.

(a) of FIG. 16 is a view illustrating an image that is displayed in a state without translated words with use of an image file including translated words at a simple level and translated words at a detailed level. (b) of FIG. 16 is a view illustrating an image that is displayed in a state where the translated words at the simple level are selected, with user of the image file including the translated words at the simple level and the translated words at the detailed level. (c) of FIG. 16 is a view illustrating an image that is displayed in a state where both the translated words at the simple level and the translated words at the detailed level are selected, with use of the image file including the translated words at the simple level and the translated words at the detailed level.

FIG. 17 is a flow chart illustrating a flow of processes in a case where a plurality of translated-word images are embedded in an image file.

FIG. 18 is a block diagram illustrating an example arrangement in a case where the present invention is applied to a color image reading apparatus.

FIG. 19 is a block diagram illustrating an internal configuration of a file generation section of an image forming apparatus that has a function of processing an image file inputted from an external device.

FIG. 20 is a flow chart illustrating a method for recognizing a format of an image file that is stored in a storage section.

### DESCRIPTION OF EMBODIMENTS

### (1) Overall Structure of Image Forming Apparatus

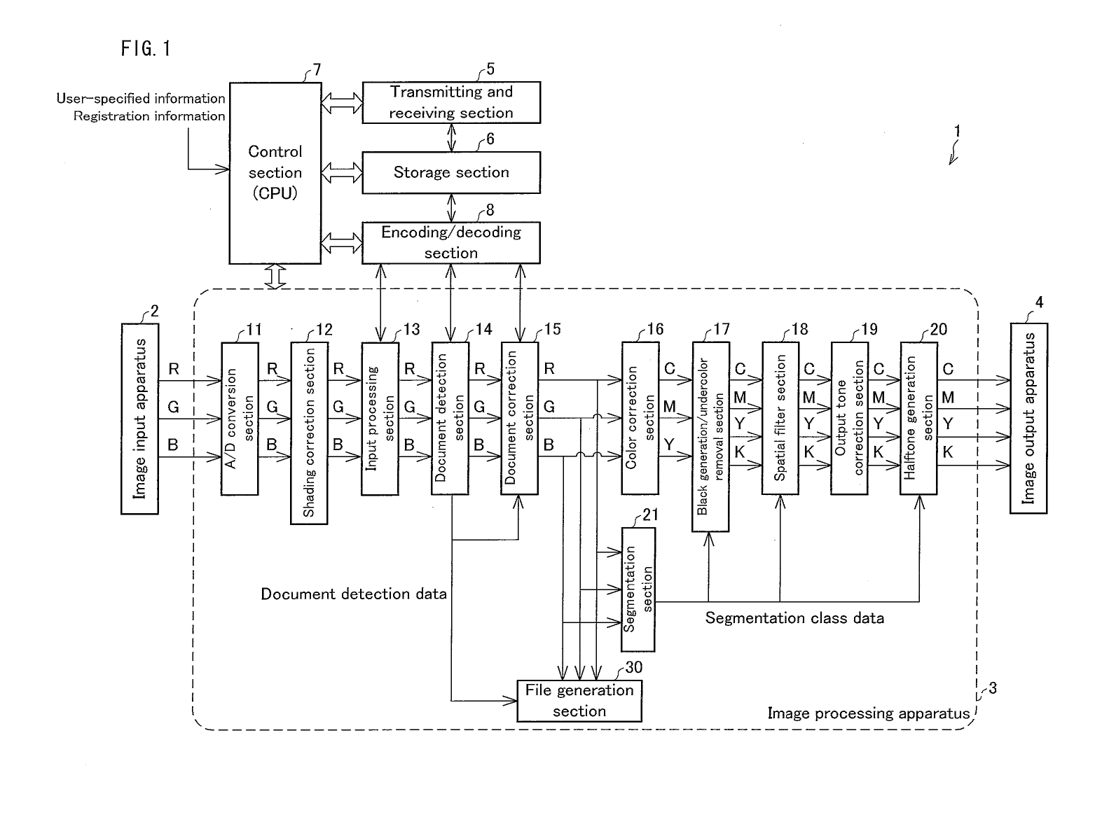

FIG. 1 is a block diagram schematically illustrating an arrangement of an image forming apparatus 1 including an image processing apparatus 3 according to the present embodiment. Note that the image forming apparatus 1 of the present embodiment is a digital color multifunction peripheral that has functions such as a copying function, a printing function, a facsimile transmitting function, and a scan to e-mail function, but the image forming apparatus 1 may alternatively be a digital color copying machine.

As illustrated in FIG. 1, the image forming apparatus 1 includes an image input apparatus 2, the image processing apparatus 3, an image output apparatus 4, a transmitting and receiving section 5, a storage section 6, a control section 7, and an encoding/decoding section 8. Further, the image processing apparatus 3 includes an A/D conversion section 11, a shading correction section 12, an input processing section 13, a document detection section 14, a document correction section 15, a color correction section 16, a black generation/undercolor removal section 17, a spatial filter section 18, an output tone correction section 19, a halftone generation section 20, a segmentation section 21, and a file generation section 30.

The image forming apparatus 1 is capable of carrying out (i) a printing mode in which an image in accordance with image data read by the image input apparatus 2 is printed on a recording material by the image output apparatus 4, and (ii) a transmitting mode in which image data read by the image input apparatus 2 is transmitted, by the transmitting and receiving section 5, to a device or an apparatus communicably connected via a network or the like.

The image input apparatus 2 is a scanner including a CCD (Charge Coupled Device) line sensor, and converts light reflected from a document into electric signals (image data) of R (red), G (green) and B (blue) color components. Note that the image input apparatus 2 is not specifically limited in arrangement, but may be, for example, an image input apparatus arranged to read a document placed on a scanner platen or an image input apparatus arranged to read a document being carried by document carrying means (document feed system).

In the printing mode (printing operation), the image processing apparatus 3 outputs CMYK image data to the image output apparatus 4. The CMYK image data is obtained by subjecting image data inputted from the image input apparatus 2 to various kinds of image processing. In the transmitting mode (transmitting operation), the image processing apparatus 3 carries out not only the various kinds of image processing on the image data inputted from the image input apparatus 2 but also character recognition process and a translation process based on the image data. The image processing apparatus 3 also generates an image file by use of results of the character recognition process and the translation process, and then transmits the image file to a storage destination or transmission destination that is specified by a user. Note that blocks in the image processing apparatus 3 will be discussed in detail later.

The image output apparatus 4 outputs (prints), on a recording material (e.g., paper), an image of the image data inputted from the image processing apparatus 3. The image output apparatus 4 is not specifically limited in arrangement. It is possible to use, for example, an electrophotographic or ink-jet image output apparatus, as the image output apparatus 4.

The transmitting and receiving section 5 is configured of, for example, a modem or a network card. The transmitting and receiving section 5 connects the image forming apparatus 1 to a network via a network card, LAN cable or the like, and carries out data communication with an external device(s)/apparatus(es) (e.g., a personal computer, a server, a display device, other digital multifunction peripheral, and/or a facsimile machine) that is communicably connected to the network.

The storage section 6 is storage means (storage device) in which various kinds of data (image data, etc.) handled (processed) in the image forming apparatus 1 is stored. The storage section 6 is not specifically limited in configuration, and it is possible to use a data storage device such as a hard disk.

The encoding/decoding section 8 is configured to encode image data being processed by the image processing apparatus 3 at the time when the image data is to be stored in the storage section 6, in a case where an encoding mode is selected. In other words, in a case where the encoding mode is selected, the encoding/decoding section 8 first encodes the image data and then stores this image data in the storage section 6. On the other hand, in a case where the encoding mode is not selected, the image data is not encoded. In this case, the image data is stored in the storage section 6, without being processed by the encoding/decoding section 8. Note that the encoding mode is selected by a user by use of an operation panel that is not illustrated. The encoding/decoding section 8 also decodes image data read from the storage section 6, in a case where this image data is encoded.

The control section 7 is a process controlling device (control means) for controlling operations of sections provided in the image processing apparatus 3. This control section 7 may be provided in a main control section (not illustrated) for controlling operations of sections in the image forming apparatus 1. Alternatively, the control section 7 may be provided separately from the main control section and configured to carry out a process in cooperation with the main control section. Note that the main control section is a device that is made of, for example, a CPU (Central Processing Unit) or the like, and controls the operations of the sections in the image forming apparatus 1, based on, for example, information inputted through a UI of an operation panel (not illustrated), and a program and/or various data stored in a ROM (not illustrated) or the like. Further, the above main control section controls a data flow inside the image forming apparatus 1 and data reading and writing from or to the storage section 6.

### (2) Image Processing Apparatus 3

(2-1) Printing Mode

Next, the following discusses in more detail blocks included in the image processing apparatus 3 and operations of the image processing apparatus 3 in the printing mode.

In the printing mode, as illustrated in FIG. 1, first, the A/D conversion section 11 converts RGB analog signals inputted from the image input apparatus 2 into digital signals and outputs the digital signals to the shading correction section 12.

The shading correction section 12 receives the digital RGB signals from the A/D conversion section 11 and subjects the digital RGB signals to a process for removing various distortions produced in an illumination system, an image-focusing system and an image-sensing system of the image input apparatus 2. Then, the shading correction section 12 outputs the processed digital RGB signals to the input processing section 13.

The input processing section (input tone correction section) 13 subjects, to various processes such as a gamma correction, the RGB signals from which the various distortions are removed in the shading correction section 12. The input processing section 13 also stores, in the storage section 6, the image data having been subjected to the various processes.

The document detection section 14 reads out the image data which the input processing section 13 stored in the storage section 6, and detects a skew angle of a document image in the image data. Then, the document detection section 14 outputs the detected skew angle (detection result) to the document correction section 15. The document correction section 15 reads out the image data stored in the storage section 6 and carries out skew correction of the document, in accordance with the skew angle transmitted from the document detection section 14.

After the skew correction is carried out by the document correction section 15, the document detection section 14 also reads out the image data (image data having been subjected to the skew correction) stored in the storage section 6, and determines a top-to-bottom direction of the document based on the image data. The document detection section 14 further outputs a determination result to the document correction section 15. Then, the document correction section 15 reads out the image data stored in the storage section 6 and carries out an orientation correcting process, in accordance with the determination result of the top-to-bottom direction of the document.

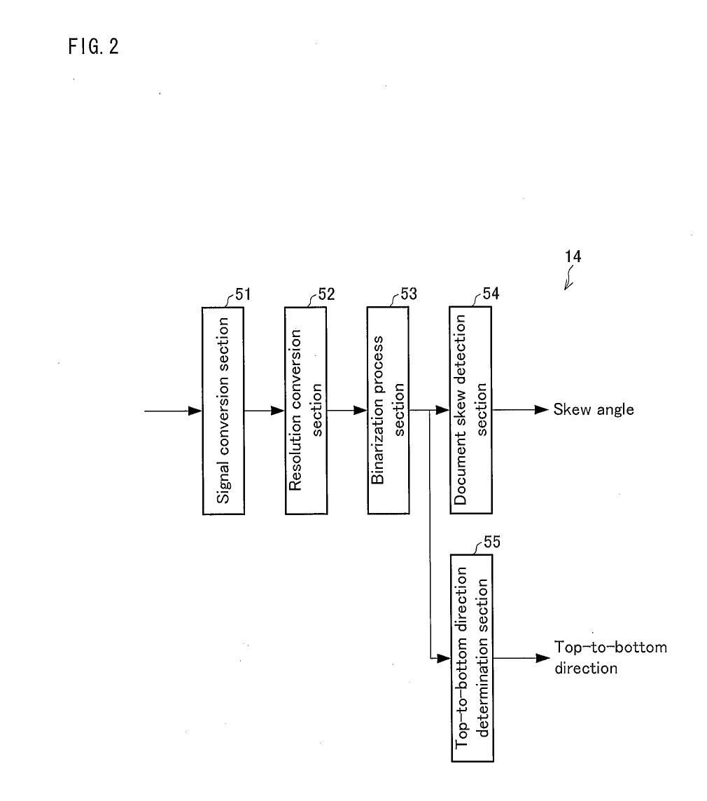

Here, the following discusses in detail the document detection section 14. FIG. 2 is a block diagram schematically illustrating a configuration of the document detection section 14. As illustrated in FIG. 2, the document detection section 14 includes a signal conversion section 51, a resolution conversion section 52, a binarization process section 53, a document skew detection section 54, and a top-to-bottom direction determination section 55.

The signal conversion section 51 converts the image data that is inputted from the storage section 6, into a lightness signal or a luminance signal. For example, the signal conversion section 51 converts the RGB signals (image data) to a luminance signal Y by calculating Yi=0.30 Ri+0.59 Gi+0.11 Bi, where: Y is a luminance signal of each pixel; R, G, and B are respective color components of the RGB signals of each pixel; and a subscript i is a value (i is an integer equal to or greater than 1) given to each pixel.

Alternatively, the RGB signals may be converted into a CIE1976L*a*b* signal (CIE: Commission International de l'Eclairage, L*: Lightness, a″ and b*:chromaticity).

The resolution conversion section 52 converts, into a low resolution, a resolution of the image data (luminance value (luminance signal) or lightness value (lightness signal)) having been converted into the achromatic image data by the signal conversion section 51. For example, image data read at 1200 dpi, 750 dpi, or 600 dpi is converted into image data of 300 dpi. A method for converting the resolution is not specifically limited. It is possible to use, for example, a conventionally known method such as a nearest neighbor method, a bilinear method, and a bicubic method.

The binarization process section 53 binarizes the image data by comparing the image data whose resolution is converted into a low resolution with a predetermined threshold. For example, in a case where the image data is 8-bit image data, the threshold is set to 128. Alternatively, an average value of densities (pixel values) in a block made of a plurality of pixels (e.g., 5 pixels×5 pixels) may be set as the threshold.

The document skew detection section 54 detects a skew angle of the document relative to a scanning area (normal document position) in image reading, based on the image data that has been binarized by the binarization processing section 53. Then, the document skew detection section 54 outputs a detection result to the document correction section 15.

A method of detecting the skew angle is not specifically limited. As the method, various conventionally known methods can be used. For example, a method described in Patent Literature 2 may be used. In this method, a plurality of boundary points between black pixels and white pixels (e.g., coordinates of black/white boundary points of an upper edge of each character) are extracted from the binarized image data, and coordinate data of a line of points for the boundary points is obtained. Then, based on the coordinate data of the line of points, a regression line is obtained and a regression coefficient b of the regression line is calculated according to Formula (1) below:

$$\begin{matrix} [ Formulae 1 ] & \\ b = \frac{Sxy}{Sx} & Formula ( 1 ) \\ Sx = {\sum }_{i = 1}^{n} {( {x}_{i} - x )}^{2} = {\sum }_{i = 1}^{n} {x}_{i}^{2} - {( {\sum }_{i = 1}^{n} {x}_{i} )}^{2} \text{/} n & Formula ( 2 ) \\ Sy = {\sum }_{i = 1}^{n} {( {y}_{i} - y )}^{2} = {\sum }_{i = 1}^{n} {y}_{i}^{2} - {( {\sum }_{i = 1}^{n} {y}_{i} )}^{2} \text{/} n & Formula ( 3 ) \\ Sxy = {\sum }_{i = 1}^{n} ( {x}_{i} - x ) ( {y}_{i} - y ) = {\sum }_{i = 1}^{n} {x}_{i} {y}_{i} - ( {\sum }_{i = 1}^{n} {x}_{i} ) ( {\sum }_{i = 1}^{n} {y}_{i} ) \text{/} n & Formula ( 4 )\end{matrix}$$

Note that: Sx is an error sum of squares of a variable x and Sy is an error sum of squares of a variable y; and Sxy is a sum of products each obtained by multiplying a residual of x by a residual of y. In other words, Sx, Sy and Sxy are represented by the above formulae (2) to (4).

Further, by using the regression coefficient b calculated as described above, a skew angle θ is calculated according to the following formula (5):

tan θ=b Formula (5)

The top-to-bottom direction determination section 55 determines a top-to-bottom direction of the document in the image data stored in the storage section 6, based on the image data that has been binarized by the binarization processing section 53. Then, the top-to-bottom direction determination section 55 outputs a determination result to the document correction section 15.

A method for determining the top-to-bottom direction is not specifically limited. As the method, it is possible to use various conventionally known methods. For example, a method disclosed in Patent Literature 3 may be used.

According to the method of Patent Literature 3, the character recognition process is carried out based on the image data and characters in the document are clipped (cropped) one by one so that a pattern is developed for each character. Note that this process is carried out by using the above binarized image data whose resolution is reduced to 300 dpi. The character recognition process is not necessarily carried out for all the characters. For example, by extracting a predetermined number of characters, the character recognition process may be carried out on the characters extracted.

Subsequently, a characteristic of a character pattern developed as above is matched (compared) with character pattern information made into a database in advance. A matching method may be arranged as follows: first, a character pattern of each character clipped from the image data is superimposed on database character patterns, and black and white are compared for each pixel; then, the character in the image data is distinguished as a character of a database character pattern having pixels to which all pixels of the character pattern of the character in the image data match, among from the database character patterns. Note that in a case where there is no database character pattern having pixels to which all pixels of the character pattern of the character in the image data match, the character in the image data is determined to be a character of a database character pattern having pixels to which the largest number of pixels of the character pattern of the character in the image data match. However, unless a ratio of the number of pixels that match to pixels in any of the database character patterns does not reach a predetermined matching ratio, it is determined that the character is undistinguishable.

The character recognition process is carried out for each of cases where the image data is rotated by 90°, 180°, and 270°. Then, for each of the cases where the image data is rotated by 0°, 90°, 180°, and 270°, the number of distinguishable characters is calculated. Then, a rotation angle which has the largest number of distinguishable characters is determined to be a character direction, that is, the top-to-bottom direction of the document. Further, a rotation angle is determined which rotation angle causes the top-to-bottom direction of the document image in the image data to coincide with a normal top-to-bottom direction. More specifically, on an assumption that an angle in a clockwise direction with respect to the normal top-to-bottom direction is a positive angle, the rotation angles are defined as follows: (i) 0° in a case where the top-to-bottom direction (reference direction) of the document image in the image data coincides with the normal top-to-bottom direction; (ii) 90° in a case where the top-to-bottom direction of the document image in the image data differs from the normal top-to-bottom direction by −90°; (iii) 180° in a case where the top-to-bottom direction of the document image in the image data differs from the normal top-to-bottom direction by −180°; and (iv) 270° in a case where the top-to-bottom direction of the document image in the image data differs from the normal top-to-bottom direction by −270°. The document detection section 14 outputs, to the document correction section 15 (see FIG. 1), the above rotation angle as the determination result of the top-to-bottom direction. Then, the document correction section 15 subjects the image data stored in the storage section 6, to a rotating process in accordance with the above rotation angle.

In the document detection section 14 described above, first, the image data having been processed by the input processing section 13 is read out from the storage section 6 and inputted into the signal conversion section 51. Then, the image data is subjected to processes respectively carried out by the signal conversion section 51, the resolution conversion section 52, and the binarization process section 53. Then, a skew angle is detected by the document skew detection section 54. Subsequently, the document correction section 15 reads out the image data stored in the storage section 6, and carries out skew correction on the image data in accordance with a detection result of the document skew detection section 54. The document correction section 15 further stores, in the storage section 6, the image data having been subjected to the skew correction. Thereafter, the image data having been subjected to the skew correction is read out from the storage section 6 and inputted to the signal conversion section 51. Then, the image data is subjected to processes respectively carried out by the signal conversion section 51, the resolution conversion section 52, and the binarization process section 53. Further, the top-to-bottom direction determination section 55 determines a top-to-bottom direction. After this determination, the document correction section 15 reads out the image data (the image data having been subjected to the skew correction) stored in the storage section 6 and carries out orientation correction on the image data as necessary in accordance with a determination result of the top-to-bottom direction determination section 55.

Note that in a case where the encoding mode is selected, the encoding/decoding section 8 encodes the image data that is outputted from the input processing section 13 or the document correction section 15 and that is to be stored in the storage section 6, and then this encoded image data is stored in the storage section 6. Further, in the case where the encoding mode is selected, the encoding/decoding section 8 decodes the image data that is read out from the storage section 6 and that is to be inputted into the document detection section 14 or the document correction section 15, and then this decoded image data is inputted into the document detection section 14 or the document correction section 15.

Next, the following discusses blocks subsequent to the document correction section 15 among the blocks that belong to the image processing apparatus 3 of FIG. 1. The color correction section 16 receives, from the document correction section 15, the image data having been subjected to the processes of the document detection section 14 and the document correction section 15. The color correction section 16 then converts this image data into CMY (C: cyan, M: magenta, Y: yellow) image data. These CMY colors are complementary colors of the RGB signals. In addition, the color correction section 16 carries out a process for enhancing (improving) reproducibility.

The segmentation process section 21 receives, from the document correction section 15, the image data having been subjected to the processes of the document detection section 14 and the document correction section 15. The segmentation process section 21 then segments each of the pixels of an image of the image data into one of a black text region, a color text region, a halftone dot region, and a photograph region (continuous tone region). Based on a segmentation result, the segmentation process section 21 outputs segmentation class data (segmentation class signal) to the black generation/undercolor removal section 17, the spatial filter section 18, and the halftone generation section 20. The segmentation class data is indicative of a region to which the each pixel belongs. A method of the segmentation process is not specifically limited, and it is possible to use a conventionally known method. The black generation/undercolor removal section 17, the spatial filter section 18, and the halftone generation section 20 each carry out a process suitable for each of the above regions, in accordance with the inputted segmentation class signal.

The black generation/undercolor removal section 17 carries out black generation by which a black (K) signal is generated from color-corrected three color signals of CMY, and subtracts the K signal from the original CMY signals so as to generate new CMY signals. In this way, the three color signals of CMY are converted into four color signals of CMYK.

The spatial filter section 18 carries out, in accordance with the segmentation class data, a spatial filter process (edge enhancement process and/or smoothing process) by use of a digital filter, with respect to image data of the CMYK signals inputted from the black generation/under color removal section 17, so that a spatial frequency characteristic of the image data is corrected. This makes it possible to reduce a blur or a granularity deterioration of an output image.

The output tone correction section 19 carries out an output γ correction process for outputting to a recording material such as a sheet or the like, and then outputs image data which has been subjected to the output γ correction process to the halftone generation section 20.

The halftone generation section 20 carries out, on the image data, a tone reproduction process (halftone generation) so that an image can ultimately be separated into pixels to reproduce each tone.

The image data having been subjected to the processes described above and outputted from the halftone generation section 20 is temporarily stored in a memory (not illustrated). Then, the image data stored is read out at a predetermined timing and inputted into the image output apparatus 4. The image output apparatus 4 carries out printing in accordance with the image data.

(2-2) Image Transmitting Mode

Next, the following explains in more detail an operation of the image processing apparatus 3 in the image transmitting mode, with reference to FIG. 1. Note that respective operations of the A/D conversion section 11, the shading correction section 12, and the input processing section 13 are substantially the same as those in the printing mode. Note that the image transmitting mode is arranged in a manner such that the image data having been processed by the input processing section 13 is temporarily stored in the storage section 6.

Here, in a case where a regular mode is selected in the image transmitting mode, the document detection section 14 and the document correction section 15 carries out, on the image data stored in the storage section 6, skew angle detection, skew correction, top-to-bottom direction determination, and orientation correction as in the printing mode. On the other hand, in a case where not the regular mode but a simple mode is selected in the image transmitting mode, the document detection section 14 carries out the skew angle detection and the top-to-bottom direction determination, but the document correction section 15 does not carry out any process.

In the regular mode, after the processes have been carried out by the document detection section 14 and the document correction section 15, the image data is transmitted from the document correction section 15 to the file generation section 30. Note that in the simple mode, the document correction section 15 reads out the image data from the storage section 6, and then directly transmits, to the file generation section 30, the image data that has not been subjected to various correction processes by the document correction section 15.

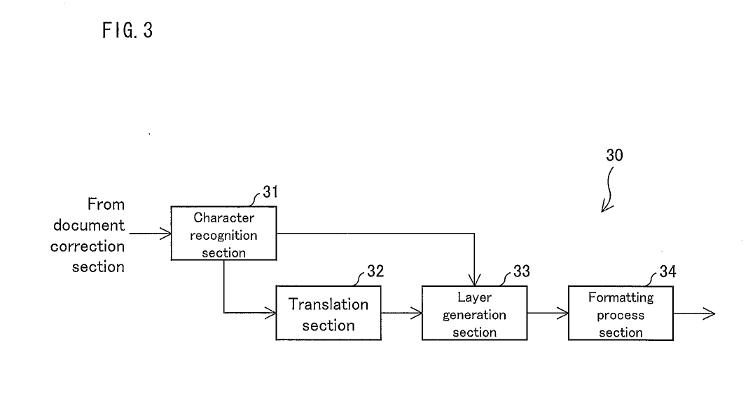

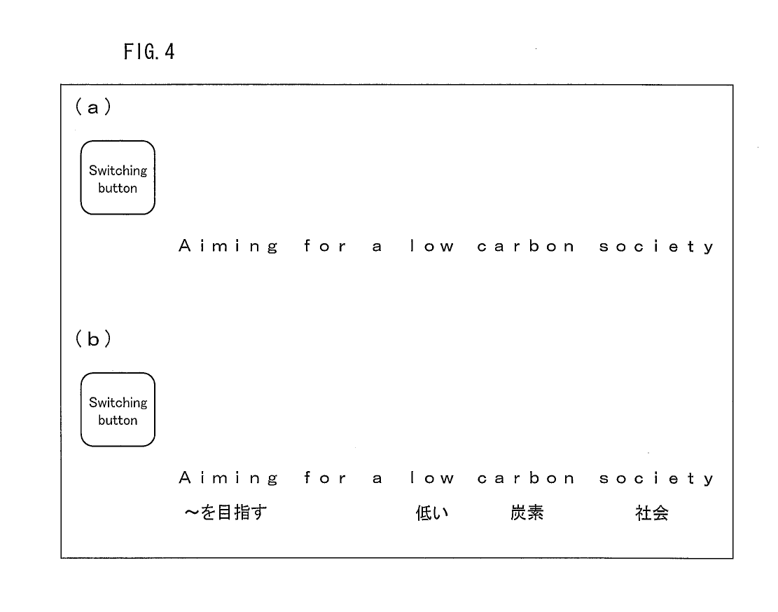

As illustrated in FIG. 3, the file generation section 30 includes a character recognition section 31, a translation section 32, a layer generation section 33 and a formatting process section 34. In a case where the image transmitting mode is selected, the file generation section 30 not only carries out a character recognition process and a translation process but also generates an image file that is to be transmitted to a transmission destination or storage destination which is specified by a user.

The character recognition section 31 converts a resolution of inputted image data to a low resolution (e.g., 300 dpi) and further binarizes the image data whose resolution has been converted into the low resolution, so as to generate binarized image data. The character recognition section 31 carries outs a character recognition process with use of this binarized image data. Further, the character recognition section 31 generates text data contained in a document corresponding to the image data, in accordance with a result of the character recognition process, and then outputs this text data to each of the translation section 32 and the layer generation section 33. Note that this text data contains a character code of each character and positional information of each character. The character recognition process is not specifically limited in method, but any conventionally known method can be employed. For example, character recognition is carried out by first extracting features of respective characters in the binarized image data and then comparing the features with dictionary data (character database). Note that the dictionary data used in the character recognition section 31 is stored in the storage section 6.

Further, the character recognition section 31 not only transmits the above text data but also forwards the inputted image data, to the layer generation section 33. In other words, the layer generation section 33 receives the text data and the image data indicative of the document, from the character recognition section 31.

The translation section 32 carries out the translation process of a language of the text data that has been transmitted from the character recognition section 31. More specifically, the translation section 32 compares the text data with dictionary data (word meaning database) including word meaning information, and obtains translated words corresponding to the language (original text) in the document. Note that the dictionary data used by the translation section 32 is stored in the storage section 6.

Further, in the present embodiment, a plurality of word meaning databases are stored in the storage section 6 so that processing contents can be switched in accordance with a translation mode. For example, in the storage section 6, various kinds of databases are stored. Such various kinds of databases includes, for example, an English-to-Japanese translation database for translating English to Japanese, an English-to-Chinese translation database for translating English to Chinese, etc. Then, the translation section 32 carries out the translation process with reference to the English-to-Japanese translation database in the storage section 6, in a case where an English-to-Japanese mode for translating English to Japanese is selected by a user. Meanwhile, in case where an English-to-Chinese mode for translating English to Chinese is selected by a user, the translation section 32 carries out the translation process with reference to the English-to-Chinese translation database in the storage section 6 (in other words, the translation section 32 switches databases to be referred to, in accordance with the translation mode).

Furthermore, in the present embodiment, for one translation mode, a plurality of word meaning databases are stored in the storage section 6 so as to correspond to respective translation levels (simple, standard, detailed). For example, in the storage section 6, a simple-level English-to-Japanese translation database, a standard-level English-to-Japanese translation database, and a detailed-level English-to-Japanese translation database are stored. The translation section 32 carries out the translation process with reference to a database of a level selected by a user. Note that the “simple level” means a level at which only difficult words are translated; the “standard level” means a level at which words from difficult words to high-school-level words are translated; and the “detailed level” means a level at which words from difficult words to basic words (junior-high-school-level words) are translated.

The layer generation section 33 generates layers constituting an image file (PDF file) that is to be generated by the subsequent formatting process section 34. More specifically, the layer generation section 33 generates the following layers: (i) a layer (hereinafter, referred to simply as a “document image”) indicative of a document image based on the document image data transmitted from the character recognition section 31; (ii) a layer (hereinafter, referred to simply as a “transparent text”) indicative of a transparent text based on the text data transmitted from the character recognition section 31; and (iii) a layer (hereinafter, referred to simply as a “translated-word image”) indicative of translated words based on a result of translation carried out by the translation section 32.

Note that the transparent text is data for superimposing (or embedding), on (or in) the document image data, recognized characters and words as text information in an invisible form in appearance. For example, in the case of a PDF file, an image file in which a transparent text is added to document image data is generally used.

The translated-word image is text data including (i) a translated text portion having a visible translated text that corresponds to an original text in the document image and (ii) a transparent portion that is a portion other than the translated text portion. The translated-word image is also data in which a position (e.g., a space that is between lines of the original text and adjacent to the original text) of the translated text is defined so that, in a case where an image file is generated by superimposing the translated-word image on the document image, a user can compare the translated text and the original text corresponding to the translated text. In other words, unlike the transparent text, the translated-word image is visible text data that is to be superimposed on the document image data in the form that allows a user to see the translated words.

Note that as a method for defining the position of the translated text relative to a position of the original text, various conventionally employed methods may be used. For example, Patent Literature 1 describes such a method in paragraphs [0063] through [0067]. The method described in Patent Literature 1 is a method of calculating, by an information insertion control section, a region where a translated text can be inserted.

The layer generation section 33 also functions as a draw command generating section that generates a draw command to be embedded in an image file that is to be generated in the subsequent formatting process section 34. This draw command is a command that is used for instructing a computer (i) as to display conditions at the time when the image file is opened and the computer is caused to display an image of the image file and/or (ii) as to printing conditions at the time when the image of the image file is to be printed.

The formatting process section 34 is a block for generating an image file that is formatted in predetermined format data, in accordance with the image data inputted into the file generation section 30 and a result of the translation process. Note that an example of the image file to be generated by the formatting process section 34 is a PDF file.

More specifically, the formatting process section 34 carries out a process for generating an image file where the layers and the draw command that are generated by the layer generation section 33 are embedded. In other words, the image file generated by the formatting process section 34 is data that includes the document image, the transparent text, and the translated-word image.

The draw command includes an initial display command, a button display command, a switch command, a printing prohibition command, and a batch-switch command as described below.

Initial Display Command: a command to cause the document image to be displayed in an arrangement where the transparent text is provided so as to be superimposed on the document image, in a case where a user inputs a display instruction with respect to an image file (in a case where the user opens the image file). In other words, the initial display command is a command to instruct the computer to cause transition to a state without translated words, in which state the translated-word image is not displayed but only the document image is displayed, in a case where the display instruction is inputted.
Button Display Command: a command to instruct the computer to display a switching button together with the document image, while the image file is open.
Switch Command: a command to instruct the computer to switch between the state without translated words and a state with translated words in a case where a user clicks the switching button (makes a button operation) so as to give a switch instruction. Note that the state with translated words is a state in which both the document image and the translated-word image are displayed in an arrangement where the translated-word image and the transparent text are superimposed on the document image.
Printing Prohibition Command: a command to instruct the computer not to print the switching button in a case where a user gives a print instruction with respect to the image file.
Batch-Switch Command: a command to instruct the computer to switch between the state without translated words and the state with translated words for all pages in a case where the document image is made of a plurality of pages and a click is made on a switching button displayed with any of the plurality of pages.

Because each command is embedded in the image file generated in the formatting process section 34, the image file is processed as follows. First, when the user makes an operation to open the image file, then the state without translated words is produced. In this state, as illustrated in (a) of FIG. 4, an original text (English) of the document image is displayed while translated words (Japanese) of the translated-word image of the image file is not displayed. As illustrated in (a) of FIG. 4, the switching button is also displayed.

Next, when a user clicks the switching button illustrated in (a) of FIG. 4, then the state without translated words as illustrated in (a) of FIG. 4 is switched to the state with translated words as illustrated in (b) of FIG. 4. In other words, when the state without translated words is switched to the state with translated words, the original text (English) of the document image of the image file and the translated words (Japanese) corresponding to the original text in the translated-word image are displayed alongside each other. In the state with translated words as illustrated in (b) of FIG. 4, the switching button is also displayed. When a user clicks the switching button illustrated in (b) of FIG. 4, the state without translated words as illustrated in (b) of FIG. 4 is switched to the state with translated words as illustrated in (a) of FIG. 4.

When a switching button displayed on any of pages is clicked, the state with translated words is switched to the state without translated words for all the pages or the state without translated words is switched to the state with translated words for all the pages. For example, when the state without translated words is switched to the state with translated words by a click made by a user on a switching button on the first page, display for second and subsequent pages is carried out also in the state with translated words.

Further, in a case where a user inputs a print command for a document image of the image file while this document image is being displayed, the switching button is not printed out even in a case where the switching button is being displayed.

The formatting process section 34 stores the image file generated as described above, in the storage section 6. Then, the transmitting and receiving section 5 transmits the image file stored in the storage section 6 to a transmission destination or storage destination which is specified by a user.

(2-3) Example Processes in Image Transmitting Mode

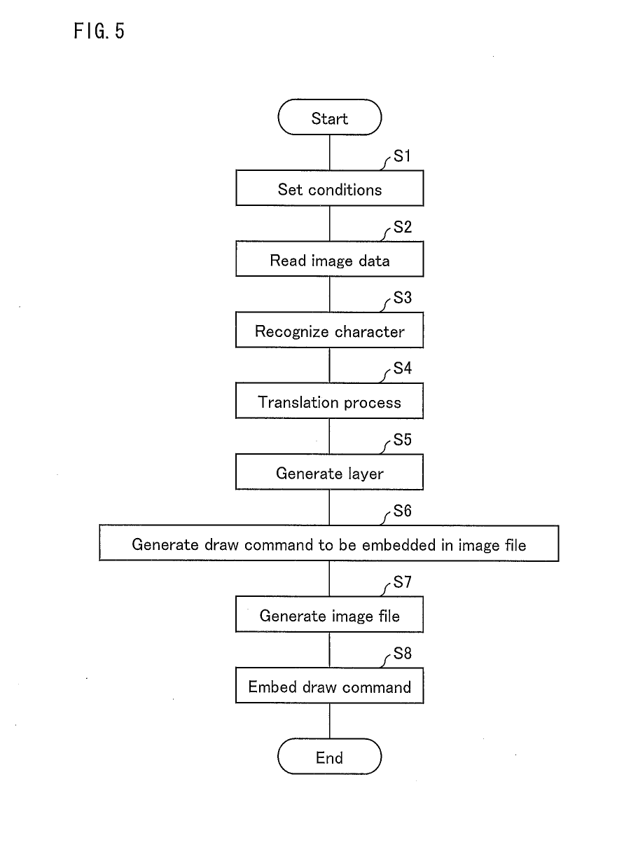

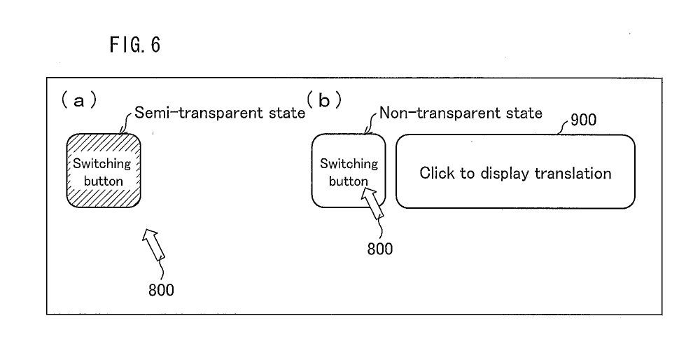

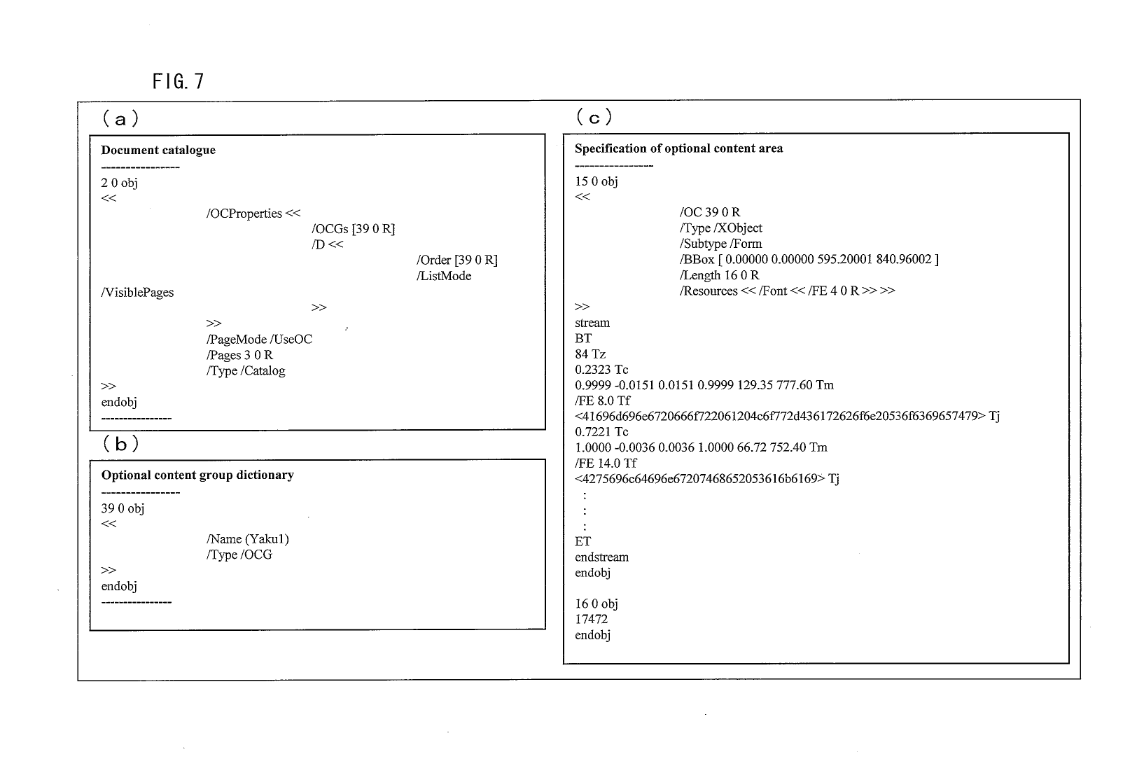

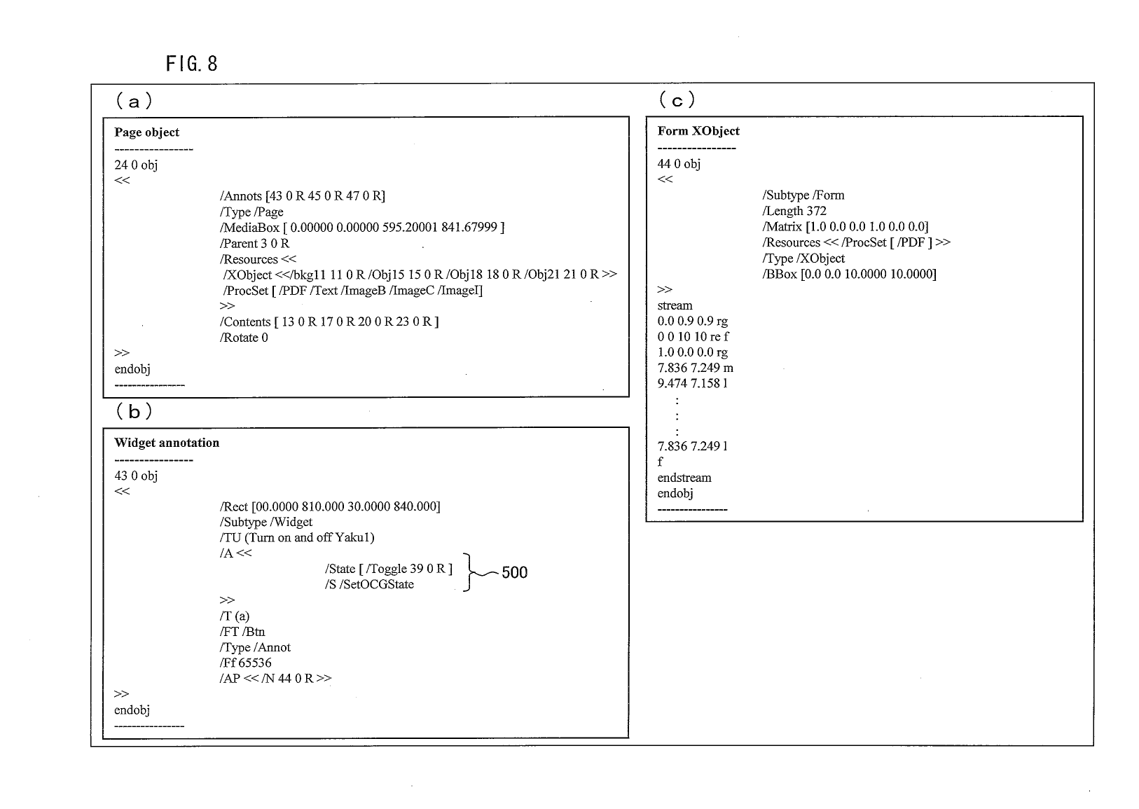

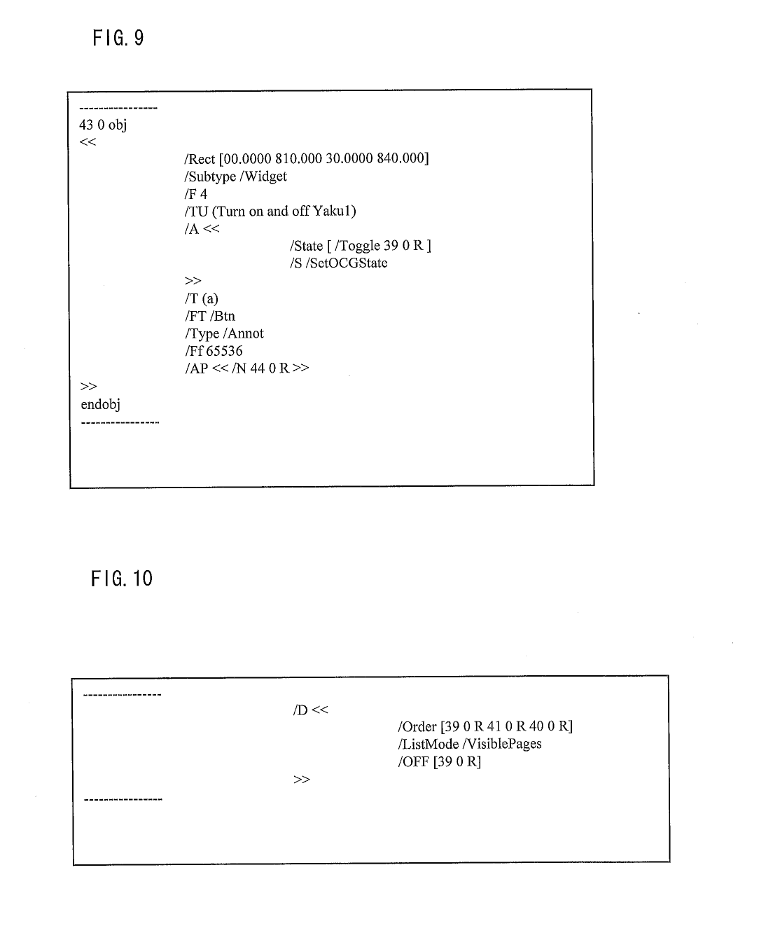

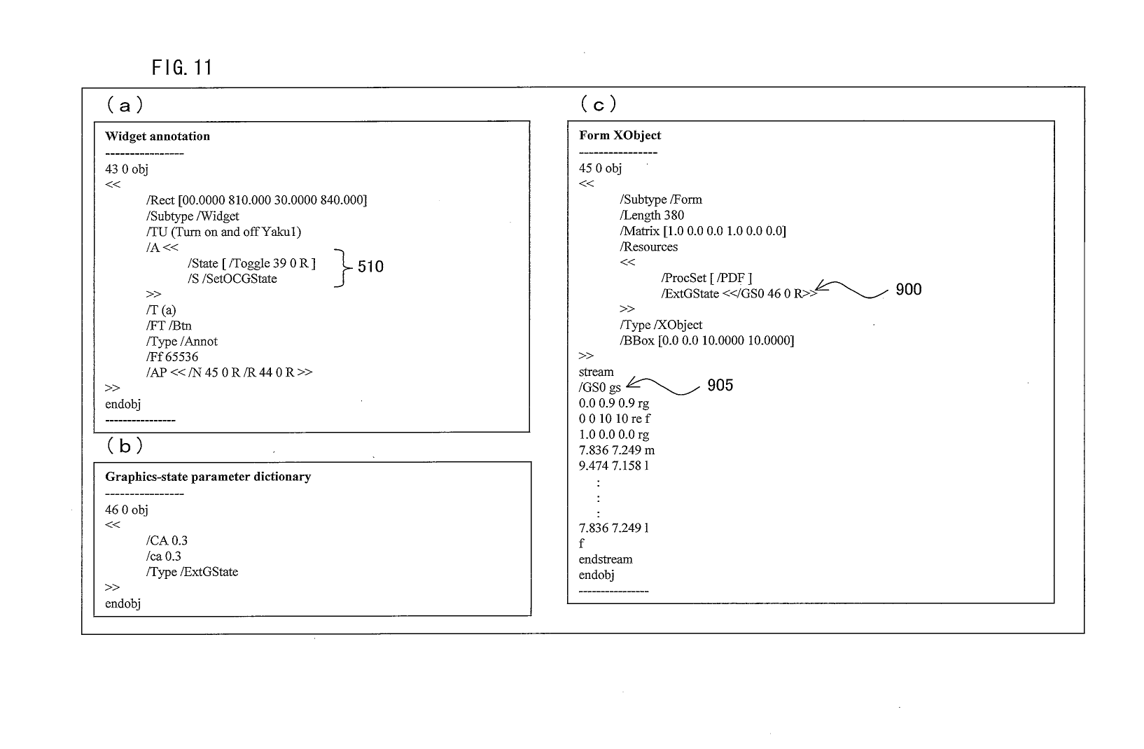

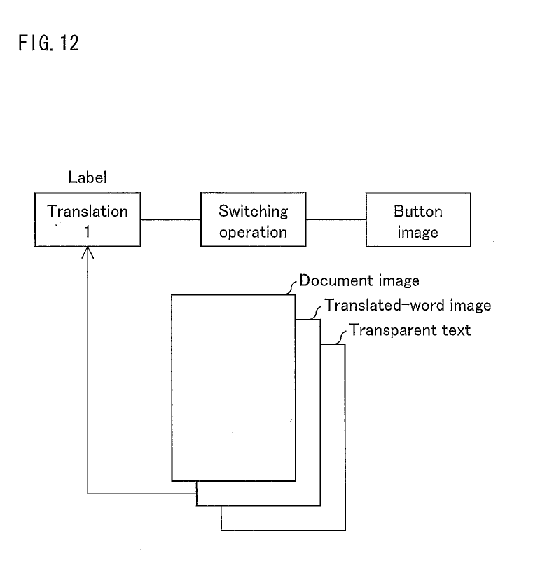

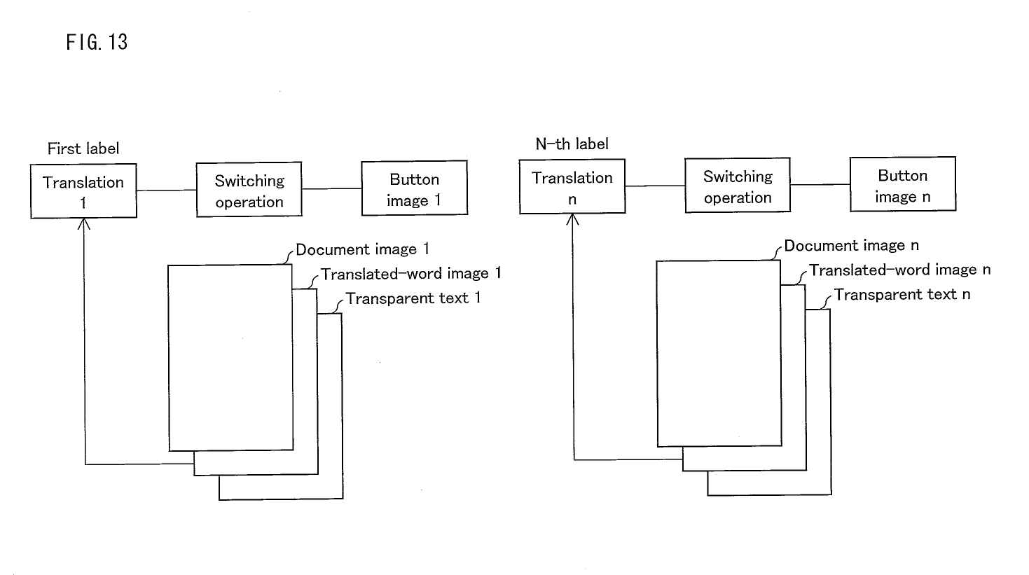

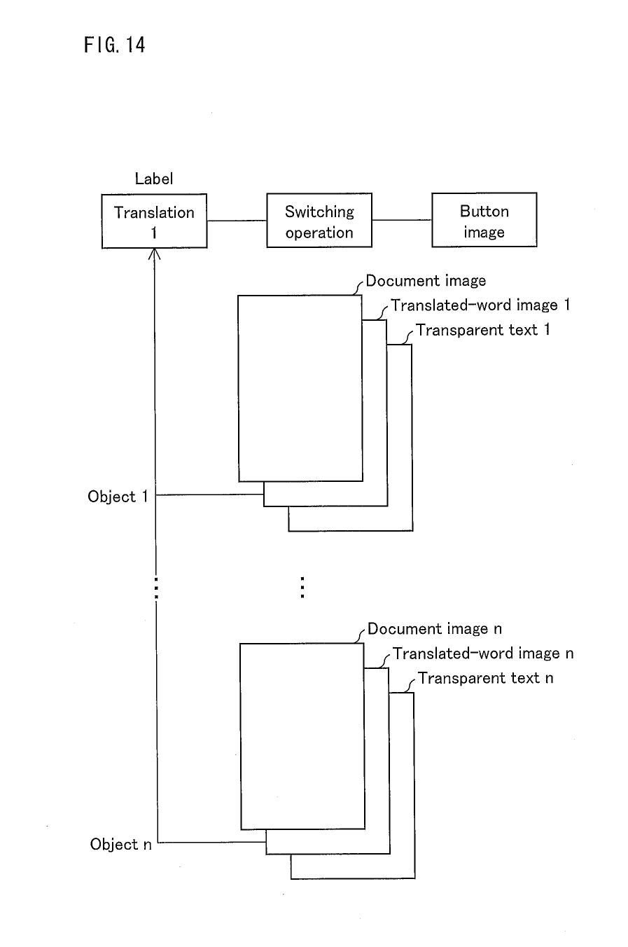

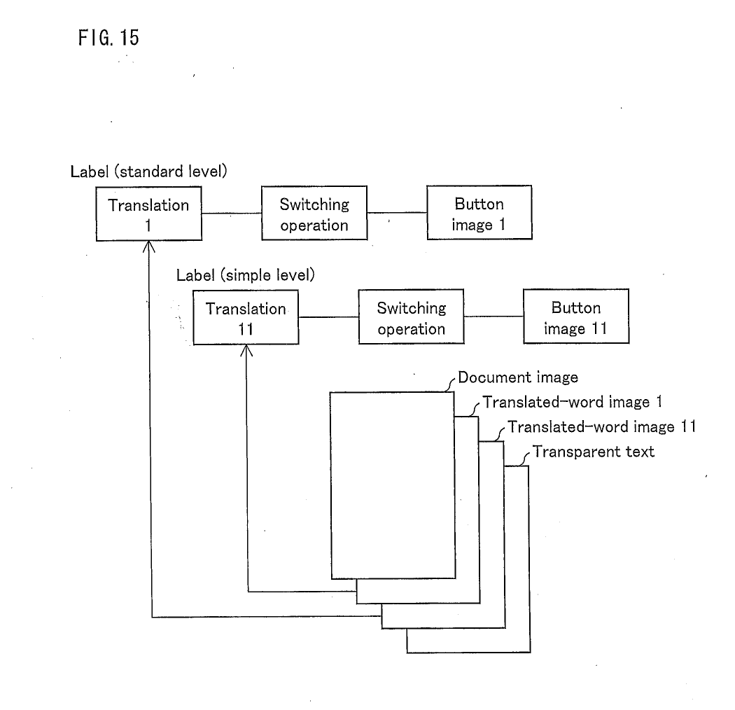

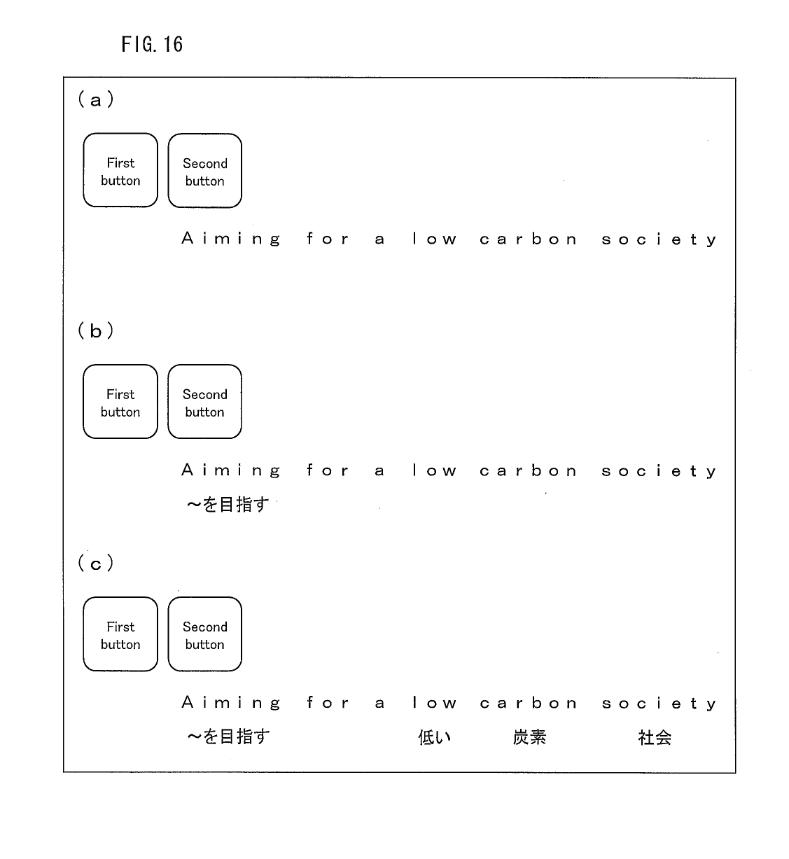

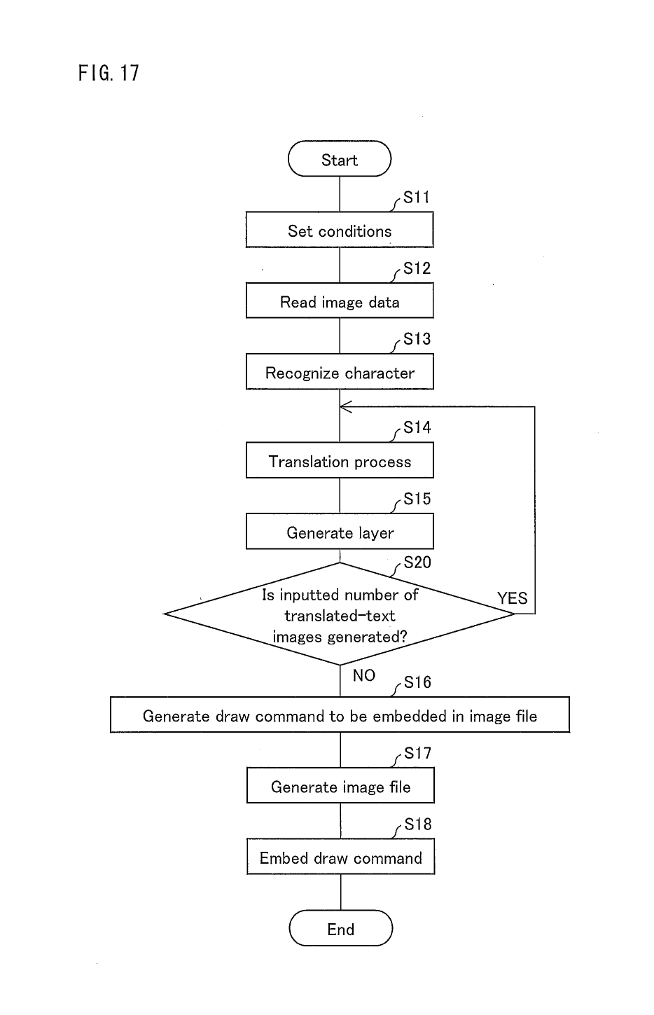

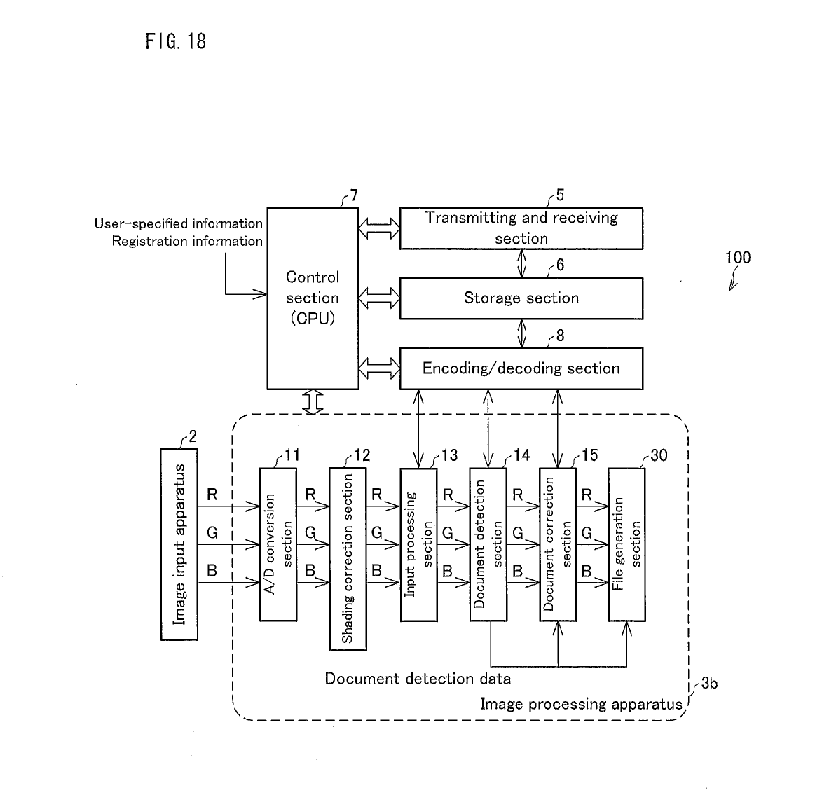

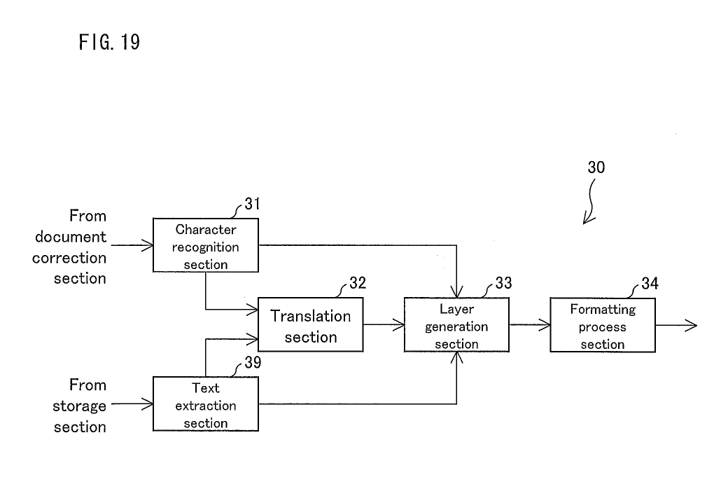

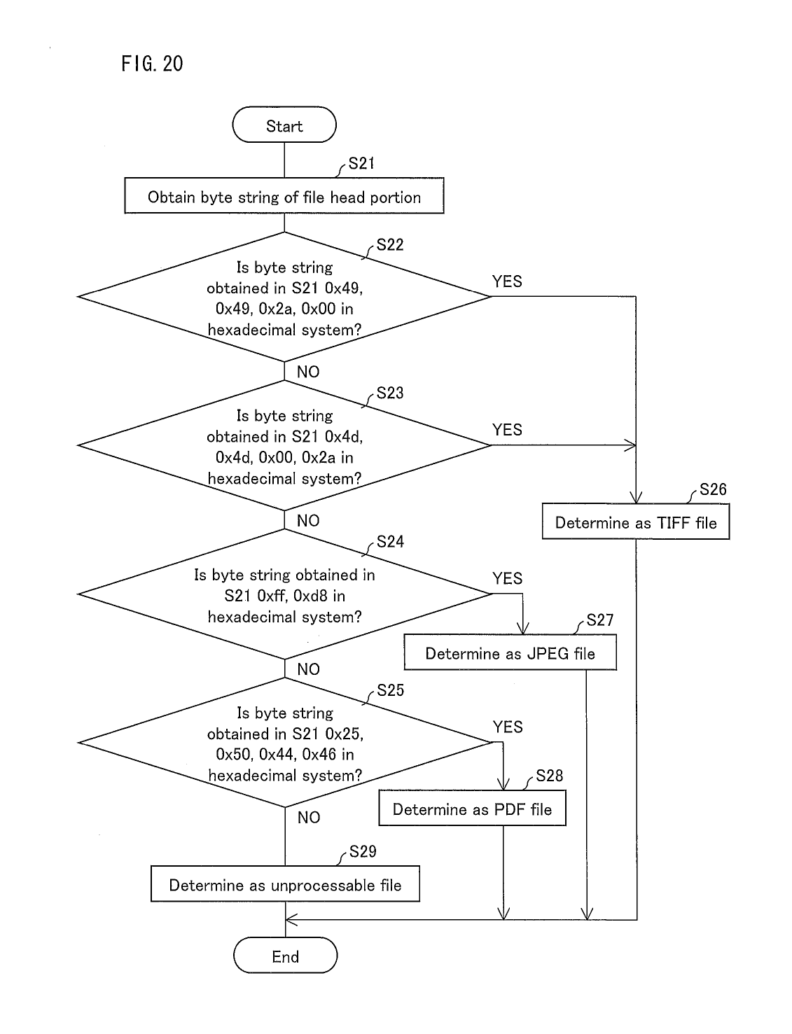

Next, the following discusses a flow of processes in the image transmitting mode, with reference to a flow chart of FIG. 5. FIG. 5 is a flow chart illustrating a flow of processes in the image transmitting mode of the image forming apparatus 1.

As illustrated in FIG. 5, first, in the image forming apparatus 1, process conditions of the image transmitting mode are set in accordance with an instruction that is inputted by a user by use of an operation panel (not illustrated) (S1).

In this S1, the user is to set whether or not to perform the translation process. Note that the flow chart of FIG. 5 is a flow chart that assumes a case where the translation process is set to be performed. The following accordingly discusses the flow of processes on the assumption that the translation process is set to be performed in S1.

In a case where the translation process is set to be performed, a screen for setting a translation mode, a translation level, and a display color of translated words is displayed. Thereby, a user is invited to set the translation mode, the translation level, and the display color. More specifically, the user is to select a desired translation mode among from an English-to-Japanese translation mode for translation from English to Japanese, an English-to-Chinese translation mode for translation from English to Chinese, a Japanese-to-English translation mode for translation from Japanese to English, a Japanese-to-Chinese translation mode from Japanese to Chinese, etc. Further, the user is to select a desired translation level among from the simple level, the standard level, and the detailed level. Note that a display color corresponding to each translation level may be set in advance. In this case, a user selects a translation level but not a display color, and a display color corresponding to the translation level selected by the user is set.
In S1, the user is to also select either the regular mode in which correction processes (the skew correction, the orientation correction) are carried out by the document correction section 15 or the simple mode in which such corrections are not carried out. Note that in a case where the simple mode is selected, a detection result (the skew angle and whether or not the top-to-bottom direction is appropriate) of the document detection section 14 is embedded in a header of the image file (PDF) that is generated in the formatting process section 34.
In addition, in S1, the user is to set an address of a transmission destination or storage destination of the image file.

When the user presses a start button on the image forming apparatus 1 after completion of setting the conditions in S1, a document is read and image data is generated (S2). In S2, a document placed on a scanner platen (contact glass) or a document being carried by a document carrying means may be read.

After S2, the image forming apparatus 1 carries out the character recognition process on the image data read from the document (S3), and also carries out the translation process based on a result of the character recognition process (S4). Subsequent to S4, the image forming apparatus 1 generates layers that constitute an image file to be generated later (S5). More specifically, the image forming apparatus 1 generates a document image (layer) based on the image data read in S2, a transparent text (layer) based on a result of the character recognition process carried out in S3, and a translated-word image (layer) based on a result of the translation process carried out in S4.

After S5, the image forming apparatus 1 generates a draw command to be embedded in the image file to be generated later (S6). The draw command generated here includes the initial display command, the button display command, the switch command, the printing prohibition command, and the batch-switch command described above. Subsequent to S6, the image forming apparatus 1 generates an image file in which the layers generated in S5 are embedded (S7), and also embeds the draw command generated in S6 in this image file (S8). Then, the image forming apparatus 1 temporarily stores, in the storage section 6, the image file generated as described above, and then transmits this image file to a transmission destination or storage destination which is specified by a user.

As described above, according to a file generation process of the present embodiment, it is possible to generate a single image file that makes it possible to switch as necessary between (i) a state with translated words (first display state) in which an original text (language) in a document and translated words corresponding to the original text are displayed together and (ii) a state without translated words (second display state) in which the language in the document is displayed but no translated word is displayed. Accordingly, it is possible to advantageously save labor in generating files and trouble in managing files, as compared to a case where two files are generated as in a conventional technique.

That is, a browser who browses the image file can switch, as necessary, between the state with translated words in which a translation result is displayed and the state without translated words in which the translation result is not displayed. Therefore, it is possible to save labor, as compared to a conventional technique that requires generation of not only a document image file according to which a translation is to be displayed but also a document image file according to which no translation is to be displayed for a person who wishes to browse a document image from which the translation is erased.

Further, according the image file generated in the present embodiment, the state with translated words as illustrated in (b) of FIG. 4 and the state without translated words as illustrated in (a) of FIG. 4 can be switched each other by a click on the switching button illustrated in (a) of FIG. 4 or (b) of FIG. 4. Accordingly, a user can easily switch between the state with translated words and the state with translated words.

Furthermore, in the present embodiment, in a case where an image in the image file is printed, the switching button is not printed. Therefore, advantageously, it is possible to omit display of an unnecessary image (switching button) on a sheet.

In a case where the image file generated in the present embodiment is made of a plurality of pages, the switching button is to be displayed on each of the plurality of pages. In addition, when a switching button on any of the plurality of pages is clicked, the state with translated words and the state without translated words are switched for all the plurality of pages. Therefore, advantageously, it is possible for a user to save labor of making a click on the switching button on each of the plurality of pages.

Further, in the image file of the present embodiment, the initial display command is embedded. The initial display command is a command to instruct a computer to cause transition to the state without translated words as illustrated in (a) of FIG. 4, in a case where a display instruction with respect to the image file is inputted by a user. Accordingly, when the image file is opened, an image is displayed first in the state without translated words as illustrated in (a) of FIG. 4. Alternatively, the initial display command may not be the command to instruct the computer to cause transition to the state without translated words as illustrated in (a) of FIG. 4 in a case where a display instruction with respect to the image file is inputted by a user, but may be a command to instruct the computer to cause transition to the state with translated words as illustrated in (b) of FIG. 4 in a case where a display instruction with respect to the image file is inputted by a user. This makes it possible to have a setting in which the image is displayed first in the state with translated words as illustrated in (b) of FIG. 4 at the time when the image file is opened.

In addition, S1 of FIG. 5 may be configured to allow a user to set (specify) by use of an operation panel whether to have, as an initial state, the state without translated words as illustrated in (a) of FIG. 4 or the state with translated words as illustrated in (b) of FIG. 4. In this case, the file generation section 30 includes an initial state specifying section (not illustrated) for specifying the state without translated words or the state with translated words as the initial state, in accordance with an instruction inputted by a user by use of the operation panel. Then, the formatting process section 34 embeds, in the image file, an initial display command to cause the computer to execute transition to a state specified as the initial state from a non-display state where the image of the image file is not displayed, in a case where a display instruction with respect to the image file is given by a user.

In other words, in a case where a user sets the state without translated words as the initial state, the formatting process section 34 embeds, in the image file, an initial display command to instruct the computer to cause transition to the state without translated words from the non-display state at the time when a display instruction with respect to the image file is inputted by a user. Meanwhile, in a case where a user sets the state with translated words as the initial state, the formatting process section 34 embeds, in the image file, an initial display command to instruct the computer to cause transition to the state with translated words from the non-display state at the time when a display instruction with respect to the image file is inputted by a user.
As a result, in a case where a main user of the image file is assumed to be a person who does not need a translation, the state without translated words as illustrated in (a) of FIG. 4 can be set as the initial display state (contents initially displayed at the time when a file is opened). Meanwhile, in a case where a main user of the image file is assumed to be a person who needs a translation (e.g., a person who is not good at languages), the state with translated words as illustrated in (b) of FIG. 4 can be set as the initial display state. This makes it possible to save labor of switching between the state without translated words and the state with translated words as much as possible.

Furthermore, although the above embodiment is arranged so that a user is to set the conditions of the translation mode, the translation level, the display color of translated words in a case where the translation process is set to be performed in S1, it is not necessary to have the user set the conditions of the translation mode and the translation level in a case where only one dictionary is stored for use in the translation process in the image forming apparatus 1. In addition, it is not necessary to have the user set the display color of the translated words, but instead, the image forming apparatus 1 may be arranged to automatically set the display color of the translated words. In this case, in S1, the user is to set whether or not to perform the translation process and the user is also to select either the regular mode in which the skew correction etc. is to be carried out or the simple mode in which the skew correction etc. is not to be carried out.

(2-4) Rollover

The switching button for switching between the state with translated words as illustrated in (b) of FIG. 4 and the state without translated words as illustrated in (a) of FIG. 4 may be configured so that rollover of the switching button (change in display state of the switching button at the time when a cursor is placed over the switching button) occurs. The following discusses this point.

(a) of FIG. 6 illustrates a switching button that is displayed in the state without translated words and the state with translated words but that is not being selected with use of a cursor 800 by a user. In a state (normal appearance state) as illustrated in (a) of FIG. 6, at least a button region that is at least a part of the switching button is displayed in a semi-transparent form. This allows a user to view an object image (not illustrated) on which the button region is superimposed, in a case where the switching button is not being selected by the user.

Then, when the cursor 800 is placed over the switching button illustrated in (a) of FIG. 6, rollover of the switching button occurs. Then, the switching button is displayed in a state as illustrated in (b) of FIG. 6. In the state as illustrated in (b) of FIG. 6 (rollover appearance), a density of the switching button becomes higher than that in the state of (a) of FIG. 6 and the button region becomes a non-transparent state. As a result, the user becomes incapable of viewing an object image on which the button region is superimposed (an object image provided in a layer below the button region). This allows the user to easily view the button region.

Further, in a case where the cursor 800 is placed over the switching button as illustrated in (b) of FIG. 6, the switching button is displayed together with a dialogue box 900. This dialogue box 900 is displayed only when the cursor 800 is placed over the switching button. The dialogue box 900 is an image (explanatory image, additional information image) showing an explanation (message, information) of a function of the switching button. Then, when the switching button is clicked in the state as illustrated in (b) of FIG. 6, the state without translated words and the state with translated words are switched as described above.

In an example as illustrated in FIG. 6, in a case where a user does not need the switching button (in a case where the cursor 800 is not placed over the switching button), it is possible to prevent the switching button from blocking display of an object image. Meanwhile, in a case where the user needs the switching button (in a case where the cursor 800 is placed over the switching button), it is possible to display the switching button in a conspicuous manner.

Further, in the example as illustrated in FIG. 6, in a case where the cursor 800 is not placed over the switching button, the dialogue box 900 is not displayed. However, in a case where the cursor 800 is placed over the switching button, the dialogue box 900 is displayed. Therefore, the dialogue box 900 can be used to explain a function of the switching button to the user. At the same time, it is possible to prevent the dialogue box 900 from impairing browsability of the image of the image file, by displaying the dialogue box 900 only at the time when the dialogue box 900 is necessary.

Note that in an embodiment where the switching button illustrated in FIG. 6 is displayed, the formatting process section 34 is configured to embed, in the image file, the following rollover display command and dialogue box display command as draw commands.

Rollover Display Command: a command to instruct a computer (i) to cause the button region to be displayed in a transparent manner to the extent that a user can view an object image in a case where a cursor is not placed over the switching button, the button region being at least a part of the switching button and superimposed on the object image, and (ii) to cause the button region to be displayed in a non-transparent manner so that a user cannot view the object image but can easily view the button image in a case where the cursor is placed over the switching button, by increasing a density of the button region as compared to a case where the cursor is not placed over the switching button.
Dialogue Box Display Command: a command to cause the computer to execute display of the dialogue box 900 that is for explaining, to a user, a function of the switching button, only in a case where the cursor is placed over the switching button.

Furthermore, the example discussed above is an embodiment in which, in a case where the cursor 800 is placed over the switching button, the button region becomes non-transparent and the object image on which the button region is superimposed becomes unviewable. However, the present invention is not limited to such an embodiment where the button region becomes non-transparent and the object image becomes unviewable. In other words, it is only necessary to arrange the present invention in a manner such that: in a case where the cursor 800 is placed over the switching button, the density of the button region is increased so that it becomes more difficult for a user to view the object image while it becomes easier for the user to view the switching button as compared to a case where the cursor 800 is not placed over the switching button. Then, it is not necessary to make the button region non-transparent and the object image unviewable.

### (3) Information Described in Image File

The following provides an example of information described (draw command embedded) in the image file. First, the following discusses information for switching between the state with translated words as illustrated in (b) of FIG. 4 and the state without translated words as illustrated in (a) of FIG. 4. FIG. 7 is a view illustrating information that is described in the image file and that is for switching between the state with translated words and the state without translated words.

(b) of FIG. 7 is an optional content group dictionary that is described in the image file. The optional content group dictionary defines a label (see FIGS. 12 to 15) that is used for organizing association between data of the image file and an action to switch between the state with translated words and the state without translated words for a case where such an action is carried out. In an example of (b) of FIG. 7, a name and a type of an object “39 0” is defined so that the object “39 0” is used as a switching label.

(a) of FIG. 7 shows a document catalogue described in the image file. The document catalogue shows information on an entire document (document image). This document catalogue is set for an object for which switching is carried out. Further, the document catalogue is set for each page and each object. An example illustrated in (a) of FIG. 7 indicates that one object “39 0” is an object for which display is to be switched.

(c) of FIG. 7 shows a description relevant to specification of an optional content area and indicates an object indicative of contents information of a translation result of each page. An example of (c) of FIG. 7 indicates that an object “15 0” is included in an area of an object with which display switching of the object “39 0” serving as a switching label is carried out.

Next, the following discusses information for displaying the switching button. FIG. 8 is a view illustrating information that is described in the image file and that is for displaying the switching button.

(a) of FIG. 8 shows a page object. The page object shows information on each page of a document. The page object also includes reference information for a case where an action (transition to display or non-display, a linked object, or the like) is made. The page object of (a) of FIG. 8 includes reference information to objects “43 0”, “45 0”, and “47 0” each including a Widget annotation as illustrated in (b) of FIG. 8.

(b) of FIG. 8 illustrates a Widget annotation that indicates an explanation of an object for which an action is to be made. A command of a reference sign 500 indicates that display and non-display of the object “39 0” are switched by the switching button. Note that in this example, the switching button is set so that the switching button is not printed (default setting). Further, “/N 44 0 R” specifies reference information to an image of the switching button, and indicates a link to a form XObject (object “44 0”) of (c) of FIG. 8.

(c) of FIG. 8 is a form XObject that defines an appearance of the switching button (a drawing image of the switching button).

In the image file, as illustrated in FIG. 12, each layer constituting the image file is associated with a label (Translation 1 in FIG. 12). This label is defined by the optional content group dictionary of (b) of FIG. 7. Further, a “switching operation” illustrated in FIG. 12 is defined by the Widget annotation of (b) of FIG. 8. In addition, a “button image” illustrated in FIG. 12 is defined by the form XObject of (c) of FIG. 8.

According to an arrangement of the image file as illustrated in FIGS. 7, 8 and 12, when the switching button illustrated in (a) of FIG. 4 or (b) of FIG. 4 is clicked, the state without translated words as illustrated in (a) of FIG. 4 and the state with translated words as illustrated in (b) of FIG. 4 can be switched each other. Further, in printing in the state without translated words (state in which a translation result is not displayed), only the document image is printed. Meanwhile, in printing in the state with translated words (state in which a translation result is displayed), the document image and the translated words are printed.

Note that by changing the Widget annotation illustrated in (b) of FIG. 8 to the contents shown in FIG. 9 (command “/F4” is inserted), the switching button is printed at the time of printing. On the contrary, in a case where a user would like the switching button not to be printed, the command “/F4” should not be inserted in the Widget annotation as illustrated in (b) of FIG. 8.

Next, the following discusses information for specifying the state without translated words as illustrated in (a) of FIG. 4, as an initial display state at the time when the image file is opened by a user. In place of “/D<<”, “/Order[39 0 R]”, and “/ListMode/VisiblePages” in the document catalogue of (a) of FIG. 7, information shown in FIG. 10 is inserted. This provides control such that the object “39 0” out of the objects “39 0”, “40 0”, and “41 0” is not displayed at the time when the file is opened. Note that whether or not to display the translated-text image (visible text information) at the time when the file is opened is set by input by use of the operation panel of the image forming apparatus 1 prior to the start of processing.

In a case where translated words in Japanese are added to an English document, the translated words in Japanese are effective information to a person who is unfamiliar with English. However, a person who is familiar with English may feel that such addition of the translated words in Japanese is annoying. In this case, the translated words in Japanese should be turned into a non-display state by clicking the switching button. Further, in a case where a paper document is converted into electronic data and stored in a folder in a server or the like and then some people share the electronic data of the paper document, it is preferable not to add the translated words. In this case, it is better not to display the translated words as a default.

In a case where the state with translated words and the state without translated words are to be switched for each page, a different label is defined for each page as illustrated in FIG. 13. Then, for each label, a label and a layer that is to be controlled with this label are associated with each other. In this case, the same embodiment or a different embodiment may be employed for display of the switching button on each page. On the other hand, in a case where the state with translated words and the state without translated words are to be switched for all pages in a batch, translated-word images for respective pages are defined as separate objects and all the pages are associated with the same label as illustrated in FIG. 14. In this case, the same embodiment is employed for display of the switching button on all the pages.

Next, the following discusses information to be added to the image file in a case of employing the embodiment (FIG. 6) that causes rollover of the switching button. FIG. 11 illustrates information that is described in the image file and that is for carrying out rollover of the switching button.

(a) of FIG. 11 illustrates a Widget annotation that indicates an explanation of an object for which an action is to be made. In other words, in an embodiment that causes rollover of the switching button, the Widget annotation of (a) of FIG. 11 is embedded in the image file in place of the Widget annotation of (b) of FIG. 8.

In (a) of FIG. 11, a command of a reference sign 510 indicates that display and non-display of the object “39 0” is switched by the switching button. Note that in this example, the switching button is set so that the switching button is not printed (default setting).

Further, “/N 45 0 R” in (a) of FIG. 11 specifies reference information to a semi-transparent drawing image (normal state) of the switching button, and indicates a link to a form XObject (object “45 0”) in (c) of FIG. 11. Further, “/R 44 0 R” in (a) of FIG. 11 specifies reference information to a non-transparent drawing image (rollover appearance) of the switching button, and indicates a link to the form XObject (object “44 0”) in (c) of FIG. 8. Note that the semi-transparent drawing image means an image of a case where the cursor is not placed over the switching button, as illustrated in (a) of FIG. 6; meanwhile, the non-transparent drawing image means an image of a case where the cursor is placed over the switching button, as illustrated in (b) of FIG. 6.

Furthermore, a text string in parentheses “0” following “/TU” in the Widget annotation of (a) of FIG. 11 defines a message to be provided in the “dialogue box 900” of (b) of FIG. 6.

(b) of FIG. 11 illustrates a graphics state parameter dictionary (semi-transparent drawing state) that defines a display rate at the time when the switching button is drawn in a semi-transparent state. In an example of (b) of FIG. 11, the display rate is set at 30% and the semi-transparent state has a transmittance of 70%.

(c) of FIG. 11 illustrates a form XObject that defines an appearance of the switching button (a drawing image of the switching button) in a case where the switching button is displayed in a semi-transparent state. The form XObject of (c) of FIG. 11 is different from the form XObject of (c) of FIG. 8 in that the form XObject of (c) of FIG. 11 has a definition for causing the switching button to be semi-transparent (reference signs 900 and 905).

### (4) Example Process where Plurality of Kinds of Translation are Carried Out

Further, the embodiment described above is arranged so that a translation mode and a translation level are set in S1 and a translated-word image (layer) indicating translated words is generated in accordance with the translation mode and the translation level which are set in S1. Here, a plurality of translation modes or a plurality of language levels may be selected at a time. In this case, a plurality of ways of translated-word images (layers) are generated.

For example, assume a case where a screen for setting the translation mode and the translation level is displayed and a user selects an English-to-Japanese translation mode and a two translation levels including a simple level and a standard level. In this case, the following two translated word images (layers) are generated: a translated-word image (layer) as a result of translation with reference to an English-Japanese dictionary of the simple level and a translated-word image (layer) as a result of translation with reference to an English-Japanese dictionary of the detailed level. Then, translation information of both the translated-word images generated is embedded in the image file.

Then, buttons are set for respective translation levels. When any of the buttons is clicked, translated words corresponding to the button clicked is displayed. For example, when an image file is first opened, an original text (English) and first and second buttons are displayed as illustrated in (a) of FIG. 16. The first button is a button for displaying the translated-word image at the simple level and the second button is a button for displaying the translated-word image at the detailed level.

When a user clicks the first button in (a) of FIG. 16, the original text and translated words at the simple level are displayed as illustrated in (b) of FIG. 16. Here, the translated words at the simple level are displayed in a blue color. Further, when the first button is clicked in a state as illustrated in (b) of FIG. 16, the translated words at the simple level is erased and a state as illustrated in (a) of FIG. 16 is restored.

On the other hand, when the second button is clicked in the state as illustrate in (b) of FIG. 16, the original text, the translated words at the simple level and translated words at the detailed level are displayed as illustrated in (c) of FIG. 16. In this case, a translated word (a translated word of “Aiming” in FIG. 16) that is present commonly in the translated words at the simple level and the detailed level is displayed in a superimposed manner as illustrated in (c) of FIG. 16. Further, in (c) of FIG. 16, the translated words at the detailed level is displayed in a green color and the translated word that is commonly present in the translated words at the simple level and the detailed level is displayed in a blue color.

Further, when the first button is clicked in the state as illustrated in (c) of FIG. 16, the state as illustrated in (c) of FIG. 16 shifts to a state where the original text and the translated words (green) at the detailed level are displayed. In this case, the color of the translated word that is commonly present at both the simple level and the detailed level (e.g., a translated word of “Aiming”) in FIG. 16 shifts to a green color that indicates that the translated word is at the detailed level. Meanwhile, when the second button is clicked in the state as illustrated in (c) of FIG. 16, the translated words at the detailed level (translated words of “low”, “carbon”, and “society”) are erased and the state as illustrated in (c) of FIG. 16 shifts to a state where the original text and the translated word (blue) at the simple level are displayed as illustrated in (b) of FIG. 16.

According to the image file as described above, it is possible to allow a browser to browse a display where a translated word result is displayed in accordance with a language level of the browser. This allows the browser to save trouble of changing a setting of the translated word level and carrying out re-scanning and re-processing. Further, it becomes possible to store, in one file, images indicating translated words of a plurality of levels.

Furthermore, for example, in a case where a screen for setting a translation mode is displayed and a user selects two modes including the English-to-Japanese translation mode and the English-to-Chinese translation mode, translation information indicating translated words in Japanese and translation information indicating translated words in Chinese are generated. Then, the translation information of both the translated words in Japanese and Chinese are embedded in the image file.

Subsequently, buttons are set for respective translation modes. When any of the buttons is clicked, translated words corresponding to the button clicked are displayed. For example, in a case where the image file is first opened, the original text (English) and buttons A and B are displayed. When the button A is selected, translated words in Japanese are displayed. Meanwhile, when the button B is selected, translated words in Chinese are displayed.

This allows a browser to browse a display where a translated word result is displayed in accordance with a mother language (a language of browser's country or a language that the browser is familiar with) of the browser. This allows the browser to save trouble of changing a setting of the language mode and carrying out re-scanning and re-processing. Further, it becomes possible to store images in one file.

Note that a flow of processes at the time when a plurality of translated-word images are embedded in the image file is as illustrated in FIG. 17. Here, S11 to S15 in FIG. 17 are the same as S1 to S5 of FIG. 5 and S16 to S18 in FIG. 17 are the same as S6 to S8 in FIG. 5. However, in FIG. 17, subsequent to S13, S14 and S15 are repeated until the number of translated-text images generated complies with the number of the translation modes and the translation levels set in S11 (YES in S20). Then, after the translated text images are generated so that the number of the translated text images complies with the number of the translation modes and the translation levels set in S11, the processes of S16 and subsequent to S16 are carried out.

### (5) Example Process where Image Data is Inputted from External Device

In the embodiment described above, the image forming apparatus 1 is arranged to carry out printing or transmission based on image data that is inputted from the image input apparatus 2. The image forming apparatus 1 may also have a function of carrying out the image transmitting mode and the printing mode based on an image file that is inputted from an external device. The following discusses an image transmitting mode of the image forming apparatus 1 that has such a function. Note that the external device indicates a USB memory (removable media) inserted into the image forming apparatus 1 or a terminal device connected with the image forming apparatus 1 via a network, etc.

In the present example, an entire arrangement of the image forming apparatus 1 is as illustrated in FIG. 1, except that a configuration of the file generation section 30 of the present example is not a configuration as illustrated in FIG. 3 but a configuration as illustrated in FIG. 19.

The file generation section 30 as illustrated in FIG. 19 includes a character recognition section 31, a translation section 32, a layer generation section 33, a formatting process section 34, and a text extraction section 39. The processing contents of the character recognition section 31, the translation section 32, the layer generation section 33, and the formatting process section 34 are similar to those illustrated in FIG. 3 and therefore, explanations thereof are omitted. In other words, in a case where in the image forming apparatus 1, the image transmitting mode is selected and a document supplied from the image input apparatus 2 is selected as an object to be processed, the character recognition section 31, the translation section 32, the layer generation section 33, and the formatting process section 34 as illustrated in FIG. 19 carries out the same processes as those in FIG. 3.

Next, the following discusses a control section 7 before the text extraction section 39 as illustrated in FIG. 19 is explained. In the present example, when the image transmitting mode is selected and an image file stored in the storage section 6 is selected as an object to be processed, the control section 7 determines whether or not text data (character data) is embedded in this image file to be processed. Note that the image file to be processed means a file that has been received via a network and the transmitting and receiving section 5 and that is stored in the storage section 6 or a file that has been read from a removable media (memory device) such as a USB memory inserted in the image forming apparatus 1 and that is stored in the storage section 6.

Then, in a case where the control section 7 determines that text data is not embedded in the image file to be processed, the control section 7 extracts image data in the image file and transmits the image data to the character recognition section 31 of FIG. 19 via the encoding/decoding section 8 and the document correction section 15. Then, the character recognition section 31 and blocks subsequent to the character recognition section 31 of FIG. 19 carry out the processes that are the same as those carried out by the character recognition section 31 and blocks subsequent to the character recognition section 31 of FIG. 3. As a result, an image file with translated words is generated.

Meanwhile, in a case where the control section 7 determines that text data is embedded in the image file to be processed, the control section 7 transmits this image file from the storage section 6 to the text extraction section 39.

The text extraction section 39 is a block that carries out a process in which (i) image data indicative of a document image and (ii) text data are extracted from the image file, when the image file is received form the storage section 6. Then, the text extraction section 39 transmits the text data extracted, to the translation section 32 and the layer generation section 33, and also transmits the image data extracted, to the layer generation section 33. Then, the translation section 32, the layer generation section 33, and the formatting process section 34 of FIG. 19 carries out the processes that are the same as those carried out in the translation section 32, the layer generation section 33, and the formatting process section 34 of FIG. 3, so that an image file with translated words is generated.

Next, the following discusses details of a determination process (process to determine whether or not text data is embedded in an image file to be processed) that is carried out by the control section 7.

First, when the image transmitting mode is selected and an image file stored in the storage section 6 is selected as an object to be processed, the control section 7 carries out processes as illustrated in FIG. 20 and thereby carries out a process to recognize a format of the image file. In the processes, a byte string of a file head portion of an image file is checked so that a file type (format) of the image file is simply recognized (In other words, the processes illustrated in FIG. 20 are arranged by putting a focus on a point that various types of image files have distinctive byte strings in file head portions (headers)). The following discusses the contents of processes as illustrated in FIG. 20.

When the image transmitting mode is selected and an image file stored in the storage section 6 is selected as an object to be processed, the control section 7 obtains a byte string in a file head portion of the image file (S21).
In a case where the byte string obtained in S21 is 0x49, 0x49, 0x2A, 0x00 in a hexadecimal system (YES in S22), that is, in a case where the file starts with 0x49, 0x49, 0x2A, 0x00, the control section 7 determines that a format of the image file to be processed is TIFF (S26).
Further, in a case where the byte string obtained in S21 is 0x4D, 0x4D, 0x00, 0x2A in a hexadecimal system (No in S22 but YES in S23), the control section 7 determines that a format of the image file to be processed is TIFF (S26).
Meanwhile, in a case where the byte string obtained in S21 is 0xFF, 0xD8 in a hexadecimal system (No in S22 and S23, but YES in S24), the control section 7 determines that a format of the image file to be processed is JPEG (S27).
In a case where the byte string obtained in S21 is 0x25, 0x50, 0x44, 0x46 in a hexadecimal system (No in S22 to S24, but YES in S25), the control section 7 determines that a format of the image file to be processed is PDF (S28).
On the other hand, in a case where the byte string obtained in S21 is not any of the byte strings shown in S22 to S25 (NO in S22 to S25), the control section 7 determines that the image file to be processed is unprocessable (S29). In this case, the transmitting mode is terminated.

The control section 7 specifies a format of the image file in the processes of FIG. 20. Then, the control section 7 determines the presence/absence of text data as below and changes where the image file is to be inputted, in accordance with the presence/absence of the text data.

First, in a case where the format specified in the processes of FIG. 20 is PDF, the control section 7 checks a text command so as to determine the presence/absence of text data in this PDF file. For example, in a file format, like a searchable PDF, in which text data is embedded in PDF, a description such as “stream BT 84 Tz . . . ” is present in the PDF file as illustrated in (c) of FIG. 7. Based on such a description, it is possible to determine that text data (character data) is embedded. On the other hand, in a case where text information is stored as a bit map image in a PDF file (in a case where the PDF file does not include text data), the above description is not included. Accordingly, it is possible to determine that text data is not embedded.

Then, in a case where the PDF file to be processed includes text data, the control section 7 reads this PDF file from the storage section 6 and inputs the PDF file into the text extraction section 39 of FIG. 19. On the other hand, in a case where the PDF file to be processed does not include text data, the control section 7 extracts image data included in this PDF file and inputs the image data into the text recognition section 31 of FIG. 19 via the encoding/decoding section 8 and the document correction section 15.

Meanwhile, in a case where the format specified in the processes of FIG. 20 is JPEG, the control section 7 recognizes the image file as an image file that does not include text data. In other words, in this case, the control section 7 extracts image data included in this JPEG file, converts the image data into RGB image data in the encoding/decoding section 8 and then inputs the image data into the character recognition section 31 of FIG. 19 via the document correction section 15.

Further, in a case where the format specified in the processes of FIG. 20 is TIFF, the control section 7 recognizes the image file as an image file that does not include text data. However, in this case, the control section 7 checks a tag of the TIFF file, and determines whether the TIFF file is a binary image file or a multi-level image file. Then, in a case where the TIFF file is a multi-level image file, the control section 7 extracts image data included in the TIFF file, converts the image data into RGB image data in the encoding/decoding section 8 and then inputs the RGB image data into the character recognition section 31 of FIG. 19 via the document correction section 15. On the other hand, in a case where the TIFF file is a binary image file, the control section 7 extracts a binary image included in the TIFF file and causes the encoding/decoding section 8 to carry out a process in which the binary image is converted into multi-level RGB image data (e.g., 8-bit image data). Then, the RGB image data outputted from the encoding/decoding section 8 is inputted into the character recognition section 31 via the document correction section 15.

In a case where image data is inputted into the character recognition section 31 or the text extraction section 39 as described above, an image file with translated words is ultimately generated in the formatting process section 34. Then, the image file is transmitted to a transmission destination or storage destination which is specified by a user.

Note that although there is no discussion of a case where the image file to be processed is electronic data such as word data, excel data, or power point data in the above embodiment of processing, such electronic data also contains text data. Accordingly, in a case where an image file to be processed is electronic data, the control section 7 reads out the electronic data from the storage section 6 and inputs the electronic data into the text extraction section 39 of FIG. 19.

### (6) Modified Example

In the above embodiment, it is possible to set a display color of a translated-word image in S1 of FIG. 5. It is possible to set a transparent color as the display color of the translated-word image. However, in a case where the display color set is a transparent color, the layer generation section 33 generates a transparent-text-format text image (layer) of the translated-word image but not a viewable text image (layer) of the translated-word image. Further, the formatting process section 34 does not embed, in an image file, various commands (initial display command, button display command, switch command, etc.) for switching the state with translated words and the state without translated words (therefore, a switching button is not displayed). This can make the translated words transparent in a case where translation information is embedded in a PDF file not for a browse purpose but for a search purpose. In an example of a case where the translation information is embedded for a search purpose, a Japanese translation is provided to an original English document, so that text search by a Japanese keyword becomes possible in electronic data of the English document.

Further, the image transmitting mode is arranged so that the image data having been processed by the document correction section 15 (in the simple mode, image data having been processed by the input processing section 13) is inputted into the file generation section 30, and an image file is generated based on this image data. However, the present invention is not limited to this arrangement. For example, the image transmitting mode may be arranged so that: (i) the color correction section 16 converts RGB image data having been processed by the document correction section 15, into R′G′B′ image data (for example, sRGB) that is suitable for a characteristic of a display device; (ii) the spatial filter section 18 carries out a spatial filter process (edge enhancement process and/or smoothing process) on this R′G′B′ image data; (iii) the output tone correction section 19 carries out tone correction on the R′G′B′ image data having been subjected to the spatial filter process; and (iv) the R′G′B′ image data having been subjected to the tone correction is inputted into the file generation section 30.

Note that although in the printing mode of the image forming apparatus 1 as described above, the image data after completion of the processes carried out by the document correction section 15 is handed over from the document correction section 15 to the color correction section 16, the present invention may be arranged so that the image data after completion of the processes carried out by the document correction section 15 is temporarily stored as a filed data in the storage section 6. In this case, for example, the image data after completion of the processes carried out by the document correction section 15 has been completed is stored in the storage section 6, after compressed in a JPEG code by a JPEG compression algorithm. Then, after a copy output operation or a print output operation is instructed, the JPEG code is taken out from the storage section (hard disk) 6, and decoded and thereby converted into RGB image data by the encoding/decoding section 8. The image data converted into the RGB image data is transmitted to the color correction section 16 and the segmentation section 21, without being processed by the document correction section 15. Meanwhile, in the image transmitting mode, the JPEG code is taken out from the storage section 6 and data transmission to an externally connected device is carried out via a network or a communication line. Note that an operation control for managing filed data or handing over data is carried out by the control section 7.

### (7) Image Reading Apparatus

The present embodiment discusses a case where the present invention is applied to a color image forming apparatus. However, the present invention is not limited to this arrangement. The present embodiment may be applied to a monochrome image forming apparatus. Further, the present invention may be applied not only to an image forming apparatus but also to an individual color image reading apparatus, for example.

FIG. 18 is a block diagram illustrating an example arrangement in a case where the present invention is applied to a color image reading apparatus (hereinafter, referred to as an “image reading apparatus”). As illustrated in FIG. 18, the image reading apparatus 100 includes an image input apparatus 2, an image processing apparatus 3b, a transmitting and receiving section 5, a storage section 6, a control section 7, and an encoding/decoding section 8. The image input apparatus 2, the transmitting and receiving section 5, the control section 7, and the encoding/decoding section 8 have substantially the same arrangement and function as those in the image forming apparatus 1 as described above, respectively, and therefore, explanations thereof are omitted.

The image processing apparatus 3b includes an A/D conversion section 11, a shading correction section 12, an input processing section 13, a document detection section 14, a document correction section 15, and a file generation section 30. The file generation section 30 has an internal configuration that is illustrated in FIG. 3 or 19. The processing contents of respective sections in the image input apparatus 2 and the image processing apparatus 3b are similar to those in the image forming apparatus 1 illustrated in FIG. 1. An image file having been subjected to the above processes in the image processing apparatus 3b is outputted to a computer, a hard disk, a network, or the like.

### (8) Other Application Example

Furthermore, the image processing apparatus of one embodiment of the present invention as described above may be applied to a system including a digital camera or mobile terminal device having a camera function, a computer, and an electronic blackboard. In this system, an image captured by the mobile terminal device is transmitted to the computer after having been subjected to at least A/D conversion by the mobile terminal device. Then, the image is subjected to an input process, a document detection process, a document correction process, and a file generation process by the computer, and then displayed on the electronic blackboard. In the mobile terminal device, an image of a document, a poster, or the like that is an image capture object whose image is to be captured, may be captured in an oblique direction. In such a case, a geometric distortion may occur in a captured image. Accordingly, in a case where whether or not a geometric distortion has occurred is determined in the document detection process, correction of the geometric distortion should be carried out. A method for correcting the geometric distortion and/or a lens distortion can be, for example, a method described in Japanese Patent Application Publication, Tokukai, No. 2010-245787. This method includes the steps of: (i) detecting edge points of the captured image; (ii) classifying the edge points into four groups which correspond to four sides of the image capture object; (iii) subjecting, to a quadratic curve approximation, the edge points which belong to each of the four groups and thereby determining four quadratic curves with respect to the respective four groups, the four quadratic curves corresponding to the respective four sides of the image capture object; (iv) finding four intersections of the four quadratic curves, the four intersections corresponding to corner sections of a region defined by the four quadratic curves; (v) obtaining a bound quadrangle in which the four quadratic curves found for the respective four sides are circumscribed, and which is congruent to a quadrangle defined by connecting the four intersections; and (vi) carrying out a transformation with respect to locations of pixels in a region where the image capture object is located in the captured image so that the edge pixels of the image capture object which has been corrected are located on the sides of the bound quadrangle, the transformation being carried out by calculations in accordance with vectors from a reference point (e.g., the centroid of the region where the image capture object is located). This method allows the lens distortion to be corrected. In addition, according to the method, the geometric distortion correction is carried out by carrying out a similar mapping transformation with respect to the bound quadrangle, which has been found as described above, in accordance with an aspect ratio (e.g., 7:10 in the case of A-/B-size used when outputting a business document) of the image capture object. A publicly-known technique can be used as the mapping transformation.

### (9) Program

The file generation section 30 of the present embodiment can be realized by software as executed by a processor such as a CPU. In such a case, the image forming apparatus 1 of the present embodiment includes: a CPU (Central Processing Unit) that executes instructions of a control program for realizing the foregoing functions of the file generation section 30; a ROM (Read Only Memory) that stores the control program, a RAM (random access memory) that develops the control program in an executable form, and a storage device (storage medium), such as a memory, that stores the control program and various types of data therein. With this arrangement, the object of the present invention is realized by a predetermined storage medium. The storage medium stores, in a computer-readable manner, program codes (executable code program, intermediate code program, and source program) of the control program of the image forming apparatus 1 of the present invention, each of which is software for realizing the aforesaid functions. The storage medium is provided to the image forming apparatus 1. With this arrangement, the image forming apparatus 1 (alternatively, CPU or MPU) as a computer reads out and executes the program codes stored in the storage medium provided.

Further, the storage medium can be a memory (not illustrated) such as a ROM or the storage medium itself can be a program medium (not illustrated) because the process is carried out by a microcomputer. Alternatively, the storage medium can be a program medium from which the program codes can be read out by carrying out loading of a storage medium with respect to a program reading device provided as an external storage apparatus (not illustrated). In any case, an arrangement can be employed in which a stored program is executed by access of a microprocessor. Alternatively, in any case, a system can be employed in which the program codes are read out and downloaded on a program storage area (not illustrated) of the microcomputer, and then the program is executed. The program for the downloading is stored in a main body in advance.

It should be noted here that the storage medium where the program codes are stored is provided in a freely portable manner. It should also be noted that the storage medium is arranged to be separable from the main body. The storage medium can be, for example, a tape, such as a magnetic tape or a cassette tape; a disk such as a magnetic disk including a flexible disk and a hard disk, or an optical disk including a CD-ROM, an MO, an MD, a DVD, and a CD-R; a card, such as an IC card (including a memory card) or an optical card; or a semiconductor memory, such as a mask ROM, an EPROM, an EEPROM, or a flash ROM. The storage media can be a medium fixedly bearing a program.

Alternatively, since the image forming apparatus 1 of the present embodiment has a system architecture which is connectable to communication networks including the Internet, the storage medium can be a medium which bears the program codes in a flexible manner so that the program code is downloaded from the communication network. Further, when the program code is downloaded over a communication network in this manner, the program for the downloading can be stored in advance in the main apparatus or installed from another storage medium.

### (10) Conclusion

In order to achieve the above object, an image processing apparatus according to one aspect of the present invention includes: a translation section carrying out a translation process of a language contained in image data so as to specify a translated word corresponding to the language; and a formatting process section generating an image file formatted into data in a predetermined format, in accordance with the image data and a result of the translation process, the formatting process section adding, to the image file, a command for causing a computer to switch between a first display state in which the language and the translated word are displayed together and a second display state in which the language is displayed without the translated word (to select a first display state in which the language and the translated word are displayed together or a second display state in which the language is displayed without the translated word) in a case where a user gives, with respect to the image file, a switching instruction to switch between the first display state and the second display state.

In the above arrangement according to one aspect of the present invention, it is possible to generate a single image file that allows switching as necessary between the first display state in which the language and the translated word are displayed together and the second display state in which the language is displayed without the translated word. Accordingly, the arrangement advantageously makes it possible to save labor in generating files and trouble in managing files, as compared to a case where two files are generated as in the conventional technique.

Further, the image processing apparatus according to one aspect of the present invention may be arranged so that the formatting process section adds, to the image file, a command for causing the computer to carry out display of a switching button in the first display state and the second display state, the switching button being used for inputting the switching instruction.

In the above arrangement, it is possible to input a switching instruction to switch between the first display state and the second display state only by a button operation with respect to the switching button. This advantageously allows the user to easily switch between the first display state and the second display state. Note that the button operation is realized, for example, by a click.

Further, the image processing apparatus according to one aspect of the present invention may be arranged so that the formatting process section adds, to the image file, a command for instructing the computer not to print the switching button in a case where a user gives a print instruction with respect to the image file.

In the above arrangement, in a case where an image of the image file is printed, the switching button is not printed. This makes it possible to prevent an unnecessary image (switching button) from being printed on a sheet.

Further, in addition to the above arrangement, the image processing apparatus according to one aspect of the present invention includes: an initial state specifying section specifying one display state between the first display state and the second display state, as an initial state in accordance with an instruction given by a user, the formatting process section adding, to the image file, a command for causing the computer to carry out change from a non-display state where no image of the image file is displayed to the one display state specified as the initial state in a case where a user gives a display instruction with respect to the image file (in a case where a user opens the image file).

This allows a user to specify one of the first display state and the second display state as an initial state at the time when the image file is opened. Accordingly, for example, when a main user of the image file is a person who does not need a translation, the second display state is specified as the initial state. Meanwhile, when a main user of the image file is a person who needs a translation (e.g., a person who is not good at languages), the first display state is specified as the initial state. Then, the number of switching between the first display state and the second display state can be reduced as much as possible.

Further, the image processing apparatus according to one aspect of the present invention may be arranged so that in a case where the image file includes a plurality of pages of images (image data), the formatting process section (i) generates the image file so that the switching button is shown in an image of each of the plurality of pages, and (ii) also adds, to the image file, a command for causing the computer to switch between the first display state and the second display state for all the plurality of pages in a case where the switching instruction is inputted by use of the switching button on any of the plurality of pages.

In the above arrangement, the above image file makes it possible to advantageously save labor of making a button operation with respect to the switching button on every page.

Further, the image processing apparatus according to one aspect of the present invention may be arranged so that: the formatting process section adds, to the image file, a command for causing the computer to carry out a process to display a button region in a transparent manner to an extent that allows a user to view an object image in a case where the switching button is not being selected by the user, the button region being at least a part of the switching button and superimposed on the object image; and the formatting process section adds, to the image file, a command for causing the computer to carry out a process to make it more difficult for a user to view the object image as well as making it easier for the user to view the button region by increasing a density of the button region in a case where the switching button is being selected by the user, as compared to a case where the switching button is not being selected by the user.

In the above arrangement, it is possible to prevent the switching button from blocking a display of the object image in a case where the switching button is not being selected by a user. Meanwhile, in a case where the switching button is necessary (in a case where the switching button is being selected by a user), the switching button can be displayed in a more conspicuous manner as compared to the case where the switching button is not being selected. Note that the switching button can be selected, for example, by placing a cursor over the switching button. Meanwhile, by separating the cursor from the switching button, the switching button is deselected.

Further, the image processing apparatus according to one aspect of the present invention may be arranged so that: the formatting process section adds, to the image file, a command to instruct the computer to display an explanatory image that explains a function of the switching button to a user only in a case where the switching button is being selected by the user.

In the above arrangement, in a case where the switching button is not being selected by a user, the explanatory image is not displayed. Meanwhile, in a case where the switching button is being selected by a user, the explanatory image is displayed. This makes it possible to explain a function of the switching button to the user by use of the explanatory image. At the same time, browsability of an image of the image file is not impaired by displaying the explanatory image only when necessary.

Further, an image forming apparatus according to one aspect of the present invention includes the image processing apparatus described above. This makes it possible to advantageously save labor in generating files and trouble in managing files, as compared to a case where two files are generated as in the conventional technique.

In addition, the image processing apparatus according to one aspect of the present invention may be realized by a computer. In this case, the scope of the present invention encompasses a program for causing the computer to operate as the sections described above to realize the image processing apparatus by the computer, and a computer-readable storage medium storing the program.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to an image processing apparatus and an image forming apparatus each of which generates an image file in accordance with image data.

### REFERENCE SIGNS LIST

1 image forming apparatus
3 image processing apparatus
3b image processing apparatus
30 file generation section
31 character recognition section
32 translation section
33 layer generation section (draw command generating section)
34 formatting process section

1. An image processing apparatus comprising:
a translation section carrying out a translation process of a language contained in image data so as to specify a translated word corresponding to the language; and
a formatting process section generating an image file formatted into data in a predetermined format, in accordance with the image data and a result of the translation process,
the formatting process section adding, to the image file, a command for causing a computer to switch between a first display state in which the language and the translated word are displayed together and a second display state in which the language is displayed without the translated word in a case where a user gives, with respect to the image file, a switching instruction to switch between the first display state and the second display state.

2. The image processing apparatus as set forth in claim 1, wherein the formatting process section adds, to the image file, a command for causing the computer to carry out display of a switching button in the first display state and the second display state, the switching button being used for inputting the switching instruction.

3. The image processing apparatus as set forth in claim 2, wherein the formatting process section adds, to the image file, a command for instructing the computer not to print the switching button in a case where a user gives a print instruction with respect to the image file.

4. The image processing apparatus as set forth in claim 1, further comprising:
an initial state specifying section specifying one display state between the first display state and the second display state, as an initial state in accordance with an instruction given by a user,
the formatting process section adding, to the image file, a command for causing the computer to carry out change from a non-display state where no image of the image file is displayed to the one display state specified as the initial state in a case where a user gives a display instruction with respect to the image file.

5. The image processing apparatus as set forth in claim 2, wherein:
in a case where the image file includes a plurality of pages of images,
the formatting process section (i) generates the image file so that the switching button is shown in an image of each of the plurality of pages, and (ii) also adds, to the image file, a command for causing the computer to switch between the first display state and the second display state for all the plurality of pages in a case where the switching instruction is inputted by use of the switching button on any of the plurality of pages.

6. The image processing apparatus as set forth in claim 2, wherein:
the formatting process section adds, to the image file, a command for causing the computer to carry out a process to display a button region in a transparent manner to an extent that allows a user to view an object image in a case where the switching button is not being selected by the user, the button region being at least a part of the switching button and superimposed on the object image; and
the formatting process section adds, to the image file, a command for causing the computer to carry out a process to make it more difficult for a user to view the object image as well as making it easier for the user to view the button region by increasing a density of the button region in a case where the switching button is being selected by the user, as compared to the case where the switching button is not being selected by the user.

7. The image processing apparatus as set forth in claim 6, wherein the formatting process section adds, to the image file, a command to instruct the computer to display an explanatory image that explains a function of the switching button to a user only in the case where the switching button is being selected by the user.

8. An image forming apparatus comprising the image processing apparatus as set forth in claim 1.

9. A non-transitory computer-readable storage medium storing a program for causing a computer to operate as each section of the image processing apparatus as set forth in claim 1.

10. (canceled)
